(19) United States
(12) Patent Application Publication
(10) Pub. No.: US 2006/0168220 A1
(43) Pub. Date: Jul. 27, 2006

(54) Network service providing method and system

(75) Inventors: Masafumi Katoh, Kawasaki (JP); Akihiro Inomata, Kawasaki (JP); Tetsuya Yokota, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/094,768

(22) Filed: Mar. 31, 2005

(30) Foreign Application Priority Data
Dec. 21, 2004 (JP) 2004-369868

(51) Int. Cl. G06F 15/173

(52) U.S. Cl. 709/225

(57) ABSTRACT

This invention is to enable to provide a network service, flexibly and quickly. In an embodiment of the invention, a network platform is achieved by a service providing network. The network platform provides common functions such as authentication and authorization, billing, and client management, and individual functions such as session control for client terminals connected with the service providing network. The client terminal generates and registers a service program to utilize functions in the network platform via a network management interface SMI. When executing the service program, a service request for a specific function is transmitted via a service control interface SCI to the network platform, and the execution result is obtained from the specific function of the network platform. The execution entity and keeping entity of the service program are initially determined based on the detecting entity of a trigger and etc., and furthermore, when it is actually executed in the client terminal, there is a case where the execution is entrusted to the network platform, taking into account the remaining processing capability of the client terminal.

### TECHNICAL FIELD OF THE INVENTION

The present invention relates to a technique to provide a network service.

### BACKGROUND OF THE INVENTION

There is a service, which allows plural users to use applications prepared on a server connected to the Internet. In such a service, the way to combine programs on the server (the way to use when viewed from the user) is previously determined by a provider of the service, and the user cannot freely combine the plural programs on the server to use them.

US-2002-0073145-A discloses a technique to download programs with a small amount of data to a client terminal from a server to cause the programs to execute a desired data processing. Specifically, definition information is inputted by the client terminal, the server reads out setting information corresponding to the definition information and transmits it to the client terminal, and one or plural functional parts are called on the basis of the setting information. The functional part is such that plural data processings are divided into common unit processings, and a processing logic extracted from those is described. The client terminal or the processing server dynamically generates a unit processing program by the processing logic based on one or plural functional parts, and executes the one or plural generated unit processing programs in accordance with conditions based on the setting information. In this technique, there is no viewpoint such as authorization of the unit processing program. Besides, there is no disclosure on a problem in a case where plural kinds of unit processing programs are executed. Further, there is no consideration on an execution entity and a keeping entity of the unit processing program.

In the related art as described above, when the client side combines arbitrary functions prepared on the server side and the client side receives, through a network, the provision of a specific service realized by the combination of the functions, consideration is not given to the judgment as to whether or not the service can be provided, and the discrimination between plural kinds of combinations. Further, when the execution entity and the keeping entity of a program (for example, the aforementioned unit processing program) defined to receive the provision of the specific service realized by the combination of the functions are fixed, there arise a problem in flexibility, a problem in quickness of the service provision, and the like. However, these problems have not been investigated. Accordingly, in the related art, there is a problem in the flexible and quick provision of the network service.

### SUMMARY OF THE INVENTION

An object of the present invention is therefore to provide a novel technique to enable the flexible and quick provision of a network service.

An information processing method according to a first aspect of the invention is an information processing method relating to a service program in which a combination of functions to be used by a client is defined among functions provided on a network platform side, and comprises: analyzing a service program to judge whether detection of a trigger to activate the service program is performed by the client terminal or the network platform side; if it is judged that the detection of the trigger to activate the service program is performed by the client terminal, judging whether a condition on a relation between the service program and the client terminal is satisfied; and if it is judged that the condition is satisfied, determining an execution entity of the service program to be the client terminal.

As stated above, although the execution entity of the service program is basically set to the detection entity of the trigger, in a case where the client terminal is the detection entity of the trigger, the execution entity is determined from the relation between the service program and the client terminal. By determining the execution entity of the service program as stated above, it becomes possible to flexibly and quickly provide the network service.

For example, the aforementioned condition may include a condition that a processing defined in the service program is relevant to a single client terminal. For example, in a case where a processing relates to a single client terminal, the client terminal is set to the execution entity, and in a case where a processing relates to plural client terminals, the network platform is set to the execution entity.

Besides, for example, the aforementioned condition may include a condition on a relation between a processing load caused for the client terminal by the service program and processing capability of the client terminal. For example, in a case where a relatively high processing load is produced by the service program though the processing power of the client terminal is low, there is a case where the suitable and quick provision of the network service can not be performed by the client terminal. Thus, the network platform is determined to be the execution entity.

Incidentally, the information processing method may further comprise: if it is judged that the detection of the trigger to activate the service program is performed by the network platform side or if it is judged that the condition is not satisfied, determining the execution entity of the service program to be the network platform; and causing the network platform to keep the service program whose execution entity is determined to be the network platform. As stated above, when the execution entity of the service program is the keeping entity, quick execution becomes possible.

An information processing method according to a second aspect of the invention is an information processing method relating to a service program that is defined by a client side for a combination of functions whose uses are authorized for the client side, among functions provided by a network platform side, and whose identification information is registered in the network platform side, and comprises: detecting a specific trigger; identifying a service program corresponding to the specific trigger; judging whether execution of the identified service program has an influence at a predetermined level or higher on the client terminal; and if it is judged that the execution of the identified service program does not have the influence at the predetermined level or higher on the client terminal, causing the identified service program to be executed.

As stated above, in the case where the trigger is detected by the client terminal, the client terminal executes the service program corresponding to the trigger in principle. However, in the case of the client terminal, there is also a case where remaining processing capability is low due to the processing of another program. Accordingly, when the service program is further executed, there is a case where a bad influence is given on the processing execution of the client terminal. Accordingly, as described above, in the case where it is judged that the execution of the service program does not have the influence at the predetermined level or higher on the client terminal, the service program is executed by the client terminal having detected the trigger.

Besides, the information processing method according to the second aspect may further include: if it is judged that the identified service program has the influence at the predetermined level or higher on the client terminal, transmitting an execution request including data concerning the specific trigger and identification information of the service program to the network platform; and receiving a processing result of the service program from the network platform. As stated above, there is also a case where the execution of the service program is entrusted to the network platform. When doing so, the provision of the network service can be received without increasing the processing load in the client terminal.

Besides, the information processing method according to the second aspect may further include: if it is judged that the execution of the identified service program does not have the influence at the predetermined level or higher on the client terminal, judging whether the identified service program is held; and if it is judged that the identified service program is not held, downloading the identified service program from the network platform. For example, in the case where the client uses a client terminal, which is not a client terminal always used, when the service program to be used can be downloaded from the network platform, convenience is improved. That is, the flexible execution of the service program becomes possible.

An information processing method according to a third aspect of the invention is an information processing method relating to a service program that is defined by a client side for a combination of functions whose uses are authorized for the client side, among functions provided by a network platform side, and whose identification information is registered in the network platform side, and comprises: detecting a trigger; judging whether the detected trigger can be handled; if the detected trigger can be handled, specifying a service program corresponding to the detected trigger; and executing the specified service program. When doing so, the trigger can be suitably processed, and the network service can be suitably provided.

Incidentally, the aforementioned judging may include: judging whether the detected trigger is a trigger relevant to the client being capable of using the network platform; and if it is judged that the detected trigger is the trigger relevant to the client being capable of using the network platform, confirming whether a service program associated with the detected trigger is defined.

It is possible to create a program for causing a computer to carry out the information processing method of the invention and a program to realize the wireless communication portable terminal, and the programs are stored in a storage medium or a storage device such as, for example, a flexible disk, a CD-ROM, a magneto-optical disk, a semiconductor memory, or a hard disk. Besides, the program may be distributed in digital signals through a network. Incidentally, the intermediate data in the processing is temporarily stored in a storage device such as a memory of a computer.

### BRIEF DESCRIPTION OF THE DRAWINGS

FIG. 1 is a block diagram of an embodiment of the invention;

FIG. 2A is a diagram showing a standard packet in SMI, and FIG. 2B is a diagram showing a standard packet in SCI;

FIG. 3 is a functional block diagram of a network platform;

FIG. 4 is a functional block diagram of a client terminal;

FIG. 5 is a diagram showing a processing flow of a service program registration processing;

FIG. 6 is a diagram showing an example of a screen displayed on a client terminal at a time of service program generation;

FIG. 7 is a diagram showing a processing flow in a case where a network platform side determines an execution entity and a keeping entity;

FIG. 8 is a diagram showing an example of data stored in a client data storage;

FIG. 9 is a diagram showing an example of data stored in the client data storage;

FIG. 10 is a diagram showing a processing flow of an execution entity determination processing at a time of the service program registration;

FIG. 11 is a diagram showing an example of data stored in a service program data storage in a network platform;

FIG. 12 is a diagram showing a processing flow of a keeping entity determination processing;

FIG. 13 is a diagram showing an example of data stored in a service program data storage in the client terminal;

FIG. 14 is a diagram showing a processing flow in a case where the execution entity and the keeping entity are determined at a client terminal side;

FIG. 15 is a diagram showing a processing flow in a case where a trigger is detected in the client terminal;

FIG. 16 is a diagram showing a processing flow of an execution entrusting processing in the network platform side;

FIG. 17 is a diagram showing a processing flow in a case where a trigger is detected in the network platform side;

FIG. 18 is a diagram showing an outline of a processing of data transmitted to the network platform from the client terminal;

FIGS. 19A to 19F are diagrams showing examples of data at respective stages;

FIG. 20 is a diagram showing an outline of a processing of data transmitted to the client terminal from the network platform;

FIG. 21 is a diagram showing an example of the service program;

FIG. 22 is a diagram showing a processing flow at a time when a service is used through the SCI;

FIGS. 23A to 23D are diagrams showing examples of data transmitted at the time when the service is used through the SCI;

FIG. 24 is a diagram showing a processing flow at the time when the service is used through the SCI;

FIG. 25 is a diagram showing a processing flow at the time when the service is used through the SCI;

FIG. 26 is a diagram showing an example of a logic of the service program;

FIG. 27 is a diagram showing a processing flow in a case where the service program of FIG. 26 is processed by a PDA as a client terminal;

FIG. 28 is a diagram showing a processing flow in a case where the processing of the service program of FIG. 26 is entrusted to a network platform;

FIG. 29 is a diagram showing an example of a logic of the service program; and

FIG. 30 is a functional block diagram of a computer.

### DETAILED DESCRIPTION OF THE PREFERRED EMBODIMENTS

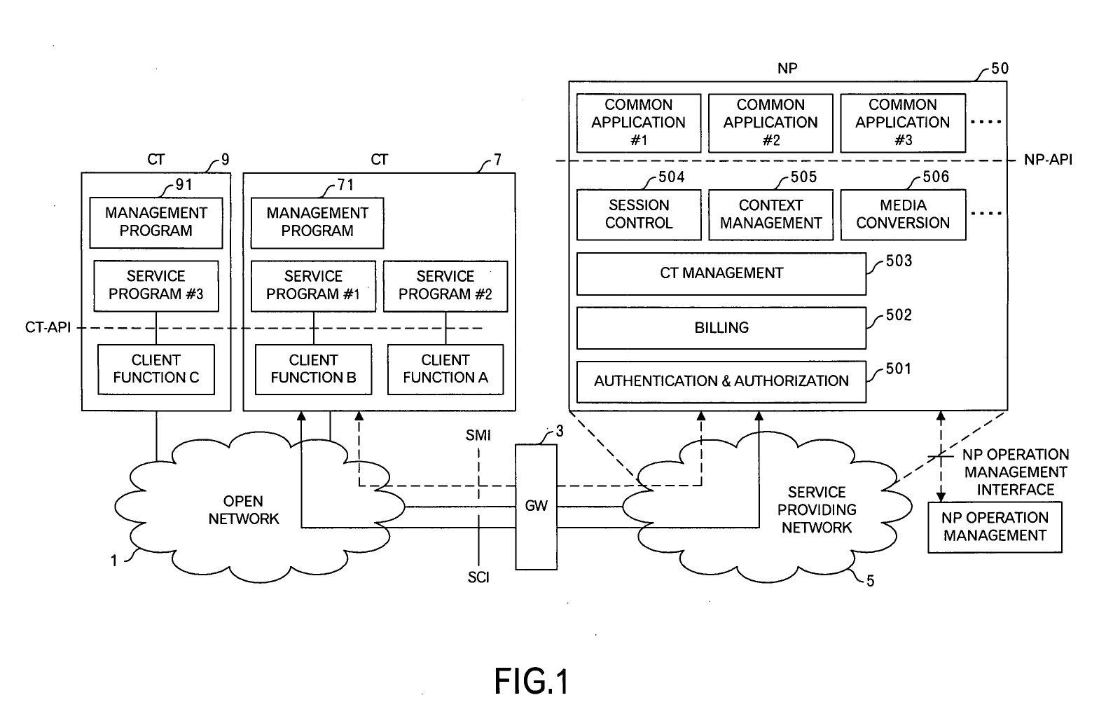

FIG. 1 is a schematic diagram of a system according to an embodiment of the invention. Plural client terminals (CT: Client Terminal) are connected to an open network 1 such as the Internet. The open network 1 is connected to a service providing network 5 through a gateway (GW: Gateway) 3. In the service providing network 5, a network platform (NP) 50 described below is constructed.

In the network platform 50, as common function modules, there are provided an authentication & authorization function module 501, a billing function module 502, and a CT management function module 503. The authentication & authorization function module 501 performs client authentication, terminal authentication, service authorization and the like. The billing function module 502 collects data necessary for billing, such as the number of times of use of function modules, for example, for each client, and generates billing data, for example, for each client. The CT management function module 503 performs version management for each function module, state management of the client terminal, download control of function modules to the client terminal, registration confirmation of service programs described below, issuance of a service ID and the like.

Besides, the network platform 50 is provided with individual function modules such as a session control function module 504 for performing session control (for example, SIP (Session Initiation Protocol)), a context management function module 505 for managing presence data of clients, and a media conversion function module 506. In FIG. 1, although the three individual function modules are shown, there is also a case where other function modules are provided. Further, the network platform 50 is also provided with common applications #1, #2, #3 and the like commonly used by the individual function modules.

On the other hand, the client terminal is provided with one or plural service programs, one or plural client function modules, and a management program. In the example of FIG. 1, a client terminal 7 is provided with service programs #1 and #2, client function modules A and B, and a management program 71. With respect to the client function module, there is also a case where it is the function module downloaded from the network platform 50, or there is also a case where it is the function module previously prepared in the client terminal. Besides, a client terminal 9 is provided with a service program #3, a client function module C, and a management program 91.

Further, in the network platform 50, an NP-API (Application Program Interface) is defined between the common applications and the individual function modules. Besides, in the client terminal, a CT-API is defined between the service programs and the client function modules. For example, in the client terminal, the service program uses the function module of the client through the CT-API. Further, a service management interface (SMI: Service Management Interface) and a service control interface (SCI: Service Control Interface) are defined between the client terminals and the network platform 50. The service program is defined such that a service desired by the user of the client terminal is provided through the SCI from the network platform 50.

Next, the service management interface SMI will be described. The network platform 50 opens the function modules in the network platform 50 and parameters necessary for execution of the function modules to the public through the SMI. The user of the client terminal or a vendor of the client system acquires necessary information from the network platform 50 through the SMI and performs service program generation.

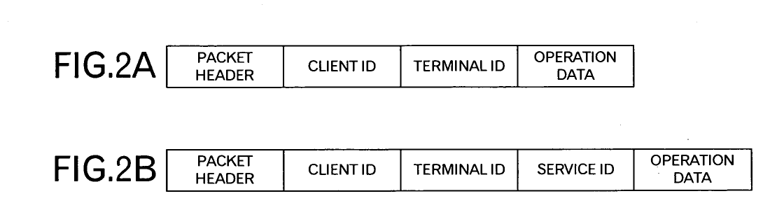

The format of a packet exchanged through the SMI is, for example, as shown in FIG. 2A. That is, the packet includes a packet header including a network address such as an IP address, a client ID, a terminal ID, and operation data. With respect to the packet from the client terminal, the operation data includes, for example, service request contents (service program registration request, function download request, version management request, state management request, etc.). With respect to the packet from the network platform 50, the operation data includes, for example, processing results and/or requested data. Besides, the format of the packet exchanged through the SCI is, for example, as shown in FIG. 2B. That is, the packet includes a packet header including a network address such as an IP address, a client ID, a terminal ID, a service ID as a service program ID, and operation data. With respect to the packet from the client terminal, the operation data includes, for example, an ID of a function module to be activated and necessary parameters. With respect to the packet from the network platform 50, the operation data includes, for example, processing results.

Besides, an NP operation management function is also prepared in the service providing network 5, and various managements concerning the network platform 50 are performed by the NP operation management function through an NP operation management interface. Incidentally, since the NP operation management function is not the main part of this embodiment, a further description will not be made.

[Configuration to Execute a Service Program]

The system outline shown in FIG. 1 shows a case in which the service program being held in the client terminal 7 or 9 is executed in response to an instruction by a user to request a processing for the function module in the network platform 50, and to receive a processing result from the function module in the network platform 50. However, when the execution entity and the keeping entity of the service program are fixed to the client terminal as stated above, the flexibility is lost. In a case where the execution entity and the keeping entity of the service program are fixedly set to the client terminal, following problem occurs. That is, when the client terminal to receive the service is not uniquely determined according to the context (i.e. state) of the client or client terminal, because there is a case where a client terminal having first executed the service program is not coincident with a client terminal to receive the final processing result as it is, the client might have to perform a troublesome processing. On the other hand, in a case where the network platform 50 is fixedly set to the execution entity, when a trigger of service program execution occurs in the client terminal, it takes a time for the network platform 50 to start the processing for the trigger. Further, in a case where the service program is fixedly stored in the client terminal, when the power supply of the client terminal is off, it becomes impossible to download the service program from the place where a person has gone. As stated above, when the execution entity and the keeping entity of the service program are fixed, the flexibility and quickness of the service provision is damaged.

Then, treatment is made possible as to all of (1) a case where the client terminal keeps the service program and the client terminal executes the service program, (2) a case where the network platform 50 keeps the service program and the client terminal downloads and executes it, (3) a case where the client terminal stores the service program and the network platform 50 downloads and executes it, and (4) a case where the network platform holds the service program and the network platform 50 executes the service program.

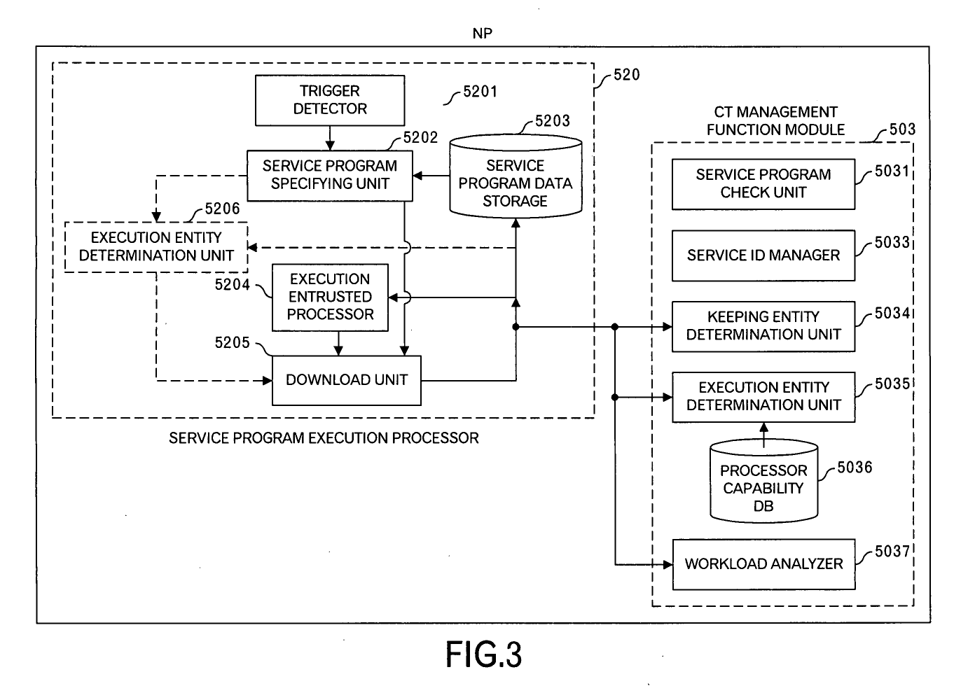

For that purpose, with respect to the network platform 50, functions as shown in FIG. 3 are additionally adopted. That is, the network platform 50 further includes a service program execution processor 520. Incidentally, although the CT management function module 503 is equal to that shown in FIG. 1, its functions are shown in detail. The service program execution processor 520 includes a trigger detector 5201, a service program specifying unit 5202, a service program data storage 5203, an execution entrusted processor 5204, and a download unit 5205, and in some cases, an execution entity determination unit 5206. The CT management function module 503 includes a service program check unit 5031, a service ID manager 5033, a keeping entity determination unit 5034, an execution entity determination unit 5035, a processor capability DB 5036, and a workload analyzer 5037.

When detecting a trigger, the trigger detector 5201 of the service program execution processor 520 outputs data of the trigger to the service program specifying unit 5202. The service program specifying unit 5202 accesses to the service program data storage 5203 storing data concerning the service programs and the service programs themselves to identify a service program, and causes the identified service program to be executed. Incidentally, in the case where the identified service program is not kept in the network platform 50, the service program specifying unit 5202 causes the download unit 5205 to download the necessary service program from a keeping site. In some cases, the service program specifying unit 5202 instructs the execution entity determination unit 5206 to determine the execution entity. The execution entity determination unit 5206 accesses to the service program data storage 5203 to determine the execution entity, and when it is judged that the network platform 50 is the execution entity, it activates the service program. Incidentally, in the case where the service program is not stored, it causes the download unit 5205 to download the service program. When downloading the service program, the download unit 5205 stores the service program into the service program data storage 5203, and activates the service program. In a case where executions entrusted from the client terminal, when the execution of the service program is requested from the client terminal, the execution entrusted processor 5204 reads out the service program from the service program data storage 5203 and causes the service program to be executed. However, when not stored, it causes the download unit 5205 to download the service program and causes the service program to be executed. The execution entrusted processor 5204 receives the processing result of the service program, and if necessary, transmits the processing result to the client terminal.

The keeping entity determination unit 5034, the execution entity determination unit 5035 and the workload analyzer 5037 of the CT management function module 503 accesses to the service program data storage 5203 and execute the processing. Besides, the keeping entity determination unit 5034 stores the service program judged to be kept in the network platform 50 into the service program data storage 5203. Incidentally, the execution entity determination unit 5035 further refers to the processor capability DB 5036 storing data concerning the processing capability of the respective terminals and performs the processing.

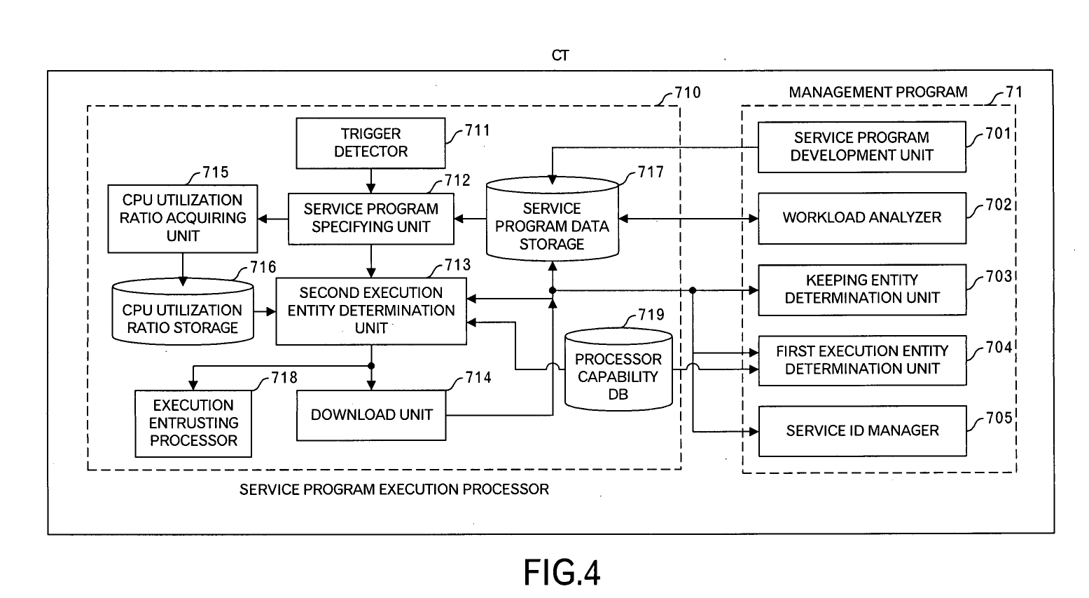

On the other hand, also with respect to the client terminal 7 or 9, functions as shown in FIG. 4 are additionally adopted. That is, the client terminal (in this description, the client terminal 7 is used as an example) further includes a service program execution processor 710. Incidentally, although the management program 71 is equal to that shown in FIG. 1, the functions are shown in detail. The service program execution processor 710 includes a trigger detector 711, a service program specifying unit 712, a service program data storage 717, a second execution entity determination unit 713, a download unit 714, a CPU utilization ratio acquiring unit 715, a CPU utilization ratio storage 716, an execution entrusting processor 718, and a processor capability DB 719 for storing data concerning the processing capability of the respective terminals. The management program 71 includes a service program development unit 701, a workload analyzer 702, a keeping entity determination unit 703, a first execution entity determination unit 704, and a service ID manager 705.

When detecting a trigger, the trigger detector 711 of the service program execution processor 710 outputs data of the trigger to the service program specifying unit 712. The service program specifying unit 712 accesses to the service program data storage 717 storing data concerning service programs and the service programs themselves, performs a processing, and identifies the service program to be executed. The service program specifying unit 712 outputs identification information of the identified service program and the data of the trigger to the second execution entity determination unit 713. The CPU utilization ratio acquiring unit 715 acquires data of the CPU activity ratio from an OS (Operating System) or the like in response to the instruction from the service program specifying unit 712, and stores it into the CPU utilization ratio storage 716. The second execution entity determination unit 713 accesses to the CPU utilization ratio storage 716, the service program data storage 717, and the processor capability DB 719 to perform a processing, and determines the execution entity of the identified service program. In the case where the second execution entity determination unit 713 judges that the service program is to be executed by the client terminal 7, the second execution entity determination unit 713 causes the service program to be executed. However, in the case where the service program is not stored in the service program data storage 717, the second execution entity determination unit 713 causes the download unit 714 to download the service program from the network platform 50. The download unit 714 activates the downloaded service program. Incidentally, when determining that the execution entity of the service program corresponding to the detected trigger is the network platform 50, the second execution entity determination unit 713 causes the execution entrusting processor 718 to perform a processing. The execution entrusting processor 718 transmits the data of the trigger and the service ID of the service program to the network platform 50 in accordance with the instruction of the second execution entity determination unit 713. Besides, the execution entrusting processor 718 receives the processing result from the network platform 50, and presents the processing result to the client terminal 7 or causes a necessary function module to perform a processing.

The service program development unit 701 of the management program 71 generates the service program, and carries out a registration processing to the network platform 50. The workload analyzer 702 accesses to the service program data storage 717 to perform a processing, and stores a processing result into the service program data storage 717. The keeping entity determination unit 703 refers to the service program data storage 717 to carry out a processing, and in the case where it is judged that the keeping entity is the client terminal 7, it stores the service program into the service program data storage 717. The service ID manager 705 issues a service ID for the service program, and stores it into the service program data storage 717. The first execution entity determination unit 704 accesses to the service program data storage 717 and the processor capability DB 719 to carry out a processing, and stores the processing result into the service program data storage 717.

The processing contents of the network platform 50 and the client terminal 7 or 9 shown in FIGS. 3 and 4 will be described below in detail.

[Processing at Time of Generation of Service Program]

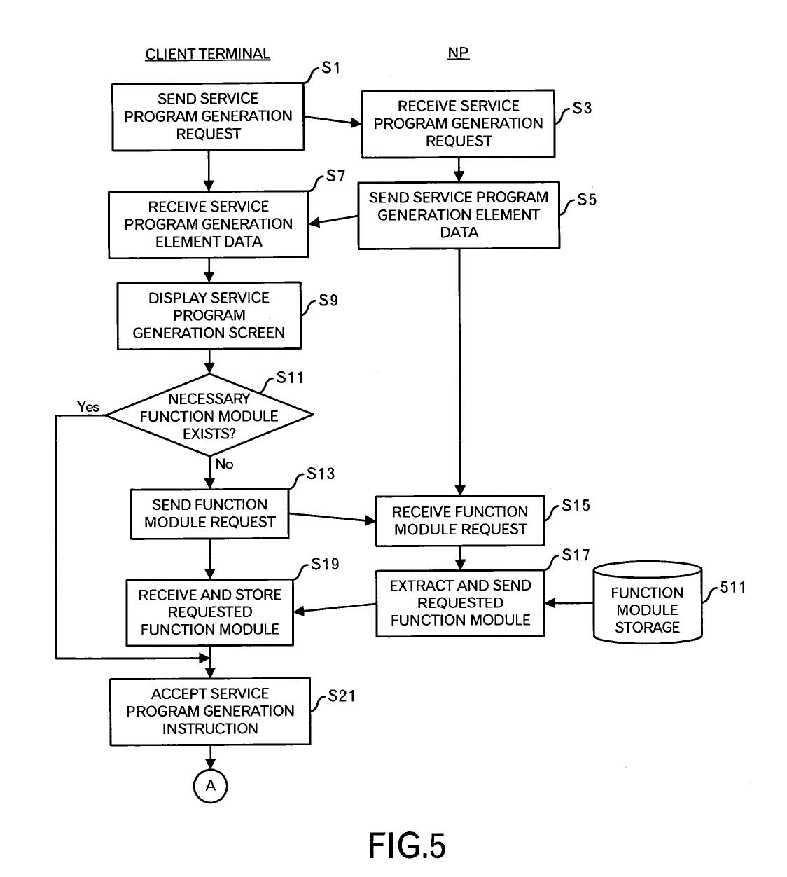

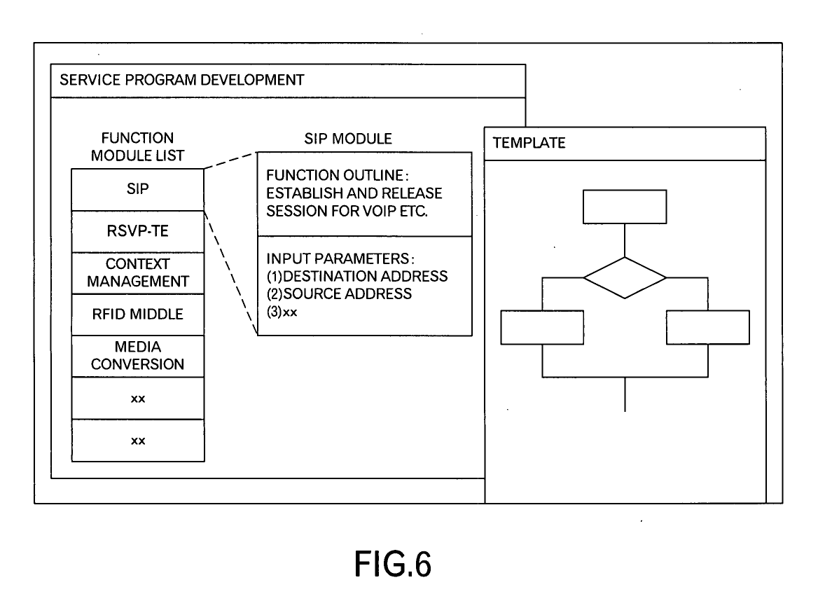

The processing at the time of generation of the service program will be described with reference to FIGS. 5 to 14. For example, the service program development unit 701 of the management program 71 in the client terminal 7 transmits a service program generation request to the network platform 50 through the SM1 (step S1). The CT management function module 503 of the network platform 50 receives the service program generation request from the client terminal 7 (step S3), and transmits service program generation element data to the client terminal 7 through the SM1 (step S5). The service program development unit 701 of the management program 71 in the client terminal 7 receives the service program generation element data from the network platform 50 (step S7), and uses the service program generation element data to display a service program generation screen (step S9). For example, a screen as shown in FIG. 6 is displayed. In the example of FIG. 6, a service program development window and a template window for logic of the service program are displayed. The service program development window includes a list of function modules open to the public in the network platform 50. Here, items such as SIP, RSVP (Resource Reservation Setup Protocol)—TE (Traffic Engineering), context management, RFID (Radio Frequency-ID) middle, and media conversion are listed. When each item is clicked, the function outline of the function module relating to the item and input parameter information are displayed. Incidentally, FIG. 6 shows a case where the SIP is selected, and the function outline and the input parameters may be displayed on a pop-up window or the like. On the template window, a typical processing logic can be selected, and FIG. 6 shows an example of such logic that a certain processing is performed at the first stage, a condition is judged at the second stage, and different processings are performed at the third stage according to the condition. While referring to the contents displayed on the service program development window, the user of the client terminal 7 causes a logic, which is consistent with a service program to be generated this time, to be displayed on the template window, and inputs processings to be carried out in the respective blocks, IDs of function modules to be used, and necessary parameters.

Incidentally, the service program development unit 701 of the management program 71 in the client terminal 7 confirms whether a necessary function module exists in the client terminal 7 (step S11). In the case where it is judged that the necessary function module do not exist in the client terminal 7, it transmits a function module request for the necessary function module to the network platform 50 through the SMI (step S13). The CT management function module 503 of the network platform 50 receives the function module request from the client terminal 7 (step S15). There is also a case where from the client ID included in packets of the received function module request, the CT management function module 503 of the network platform 50 judges whether or not the function module relating to the request can be transmitted. However, when the function module is a basic function module necessary to use the network platform 50, it is not necessary to particularly carry out a check. The CT management function module 503 reads out the function module relating to the request from the function module storage 511, and transmits it to the client terminal 7 through the SMI (step S17). When receiving the requested function module from the network platform 50, the service program development unit 701 of the management program 71 in the client terminal 7 stores it into the storage device of the client terminal (step S19).

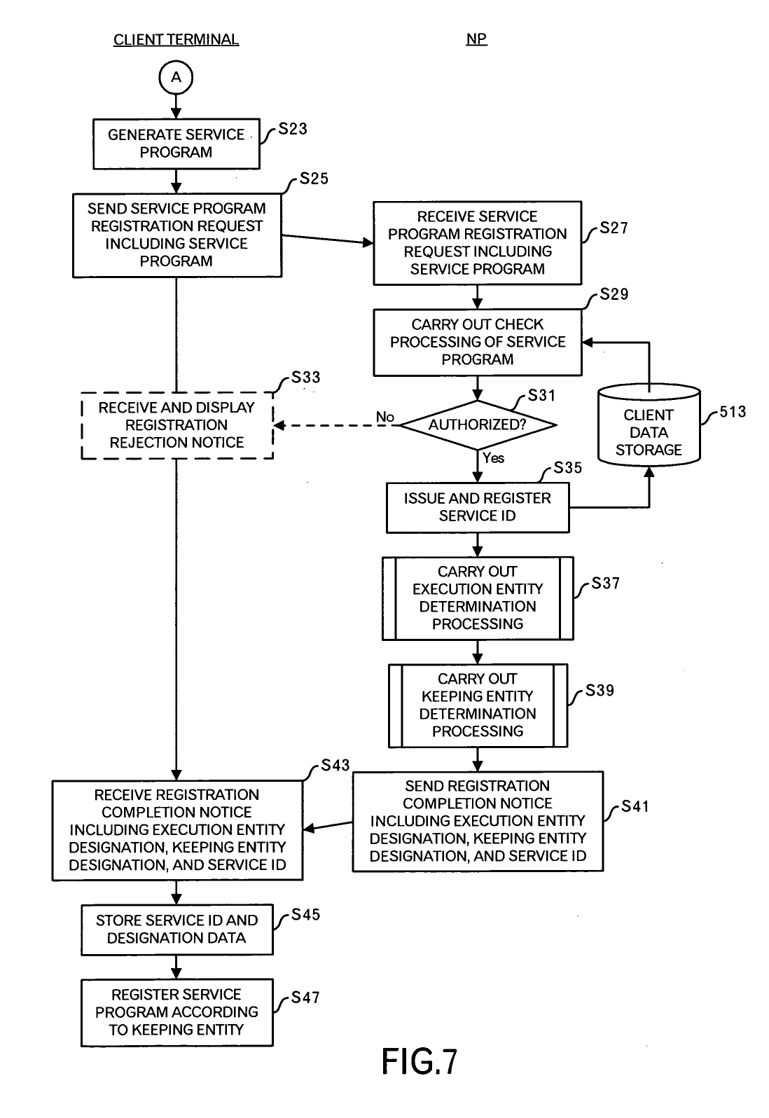

In the case where it is judged at the step S11 that the necessary function module exists in the client terminal 7, or after the step S19, the service program development unit 701 of the management program 71 in the client terminal 7 accepts a service program generation instruction from the user on the screen shown in, for example, FIG. 6 (step S21). A set of IDs of function modules authorized in the network platform 50 and necessary input parameters is designated in the blocks of the template representing the logic, and data such as conditions necessary for the logic is also designated. The processing proceeds to a processing of FIG. 7 through a terminal A.

Then, the service program development unit 701 of the management program 71 in the client terminal 7 generates a service program in accordance with the accepted input data, and stores it into the storage device (step S23). The service program development unit 701 of the management program 71 transmits a service program registration request including the service program to the network platform 50 (step S25). The service program check unit 5031 of the CT management function module 503 in the network platform 50 receives the service program registration request including the service program from the client terminal 7, and stores it into the storage device (step S27). Then, the service program check unit 5031 of the CT management function module 503 refers to a client data storage 513, and carries out a check processing to the received service program (step S29).

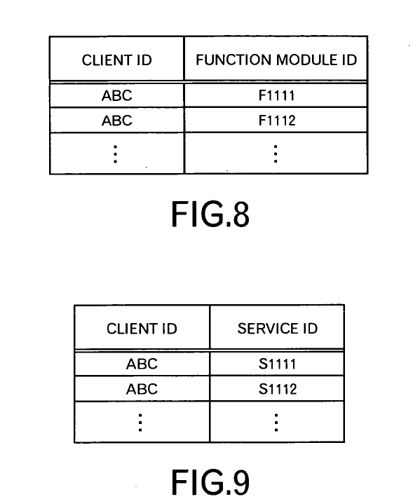

For example, data as shown in FIG. 8 is stored in the client data storage 513. In the example of FIG. 8, an ID of an authorized function module is registered correspondingly to a client ID. There is also a case where instead of such a simple table, a table defining sections to which the clients belongs is combined with a corresponding table associating the sections with IDs of authorized function modules. The service program check unit 5031 of the CT management function module 503 uses the client ID included in the service program registration request to search the table as shown in FIG. 8, identifies the IDs of the authorized function modules, and judges whether all function modules defined in the service program can be used, that is, whether the use of the service program can be authorized (step S31).

In the case where an unauthorized function module is defined in the service program, the service program check unit 5031 of the CT management function module 503 transmits a registration rejection notice to the client terminal 7. The service program development unit 701 of the management program 71 in the client terminal 7 receives the registration rejection notice from the network platform 50, and displays it on the display device (step S33). By this processing, it is possible to recognize that there is a problem in the generated service program.

On the other hand, in the case where it is judged that all the function modules defined in the service program received from the client terminal 7 can be used, the service ID manager 5033 of the CT management function module 503 issues the service ID to the service program, and registers it into the client data storage 513 (step S35). For example, as shown in FIG. 9, the service ID is registered so as to correspond to the client ID. Incidentally, the service program itself or an ID group of all defined function modules may be made to correspond to client IDs and may be registered into the client data storage 513 or another data storage for an authentication and authorization processing. With respect to the service ID, there is a case where the service ID is unique in the network platform 50, or there is a case where it is unique for each client or each client set, and either system can be adopted.

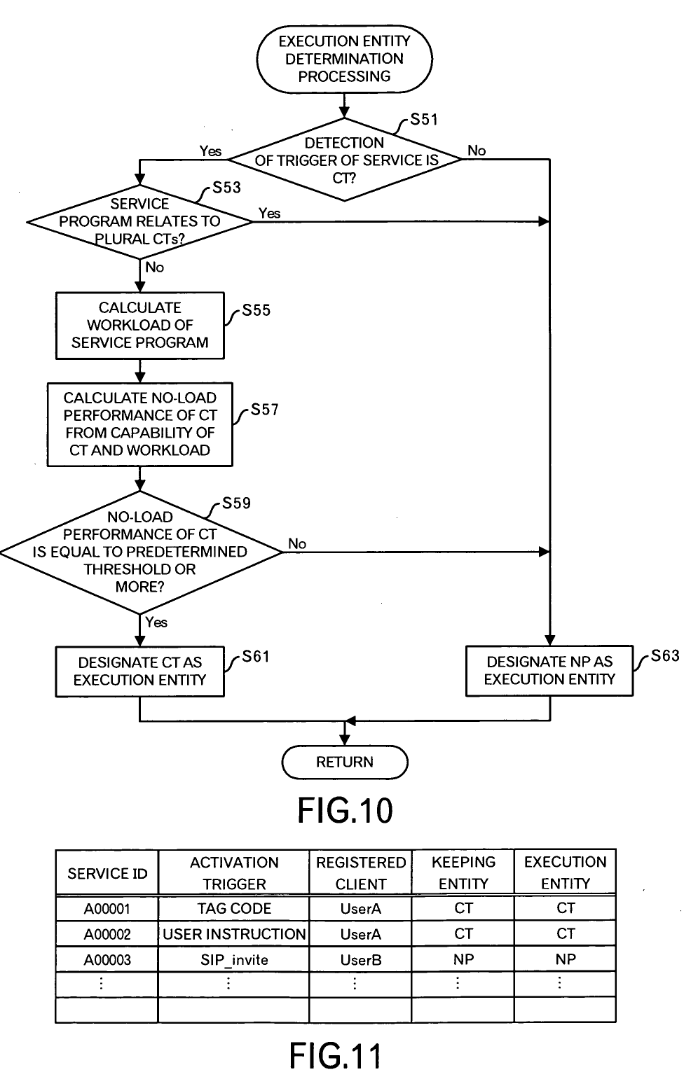

Next, the execution entity determination unit 5035 analyzes the service program, and further refers to the processor capability DB 5036 to perform an execution entity determination processing (step S37). The execution entity determination processing of the network platform 50 will be described with reference to FIG. 10. The execution entity determination unit 5035 judges whether the detection of the trigger of the service is carried out by the client terminal (step S51). The case where the detection of the trigger is carried out by the client terminal includes, for example, a case where the trigger is not particularly defined, that is, a case where the service program is executed by the instruction of a user, a case where detection or measurement by a sensor, such as the readout of an IC tag (also called an RFID) is defined, and a case where a peculiar event occurring in the client terminal is defined as the trigger. In the case where it is not judged that the detection of the trigger of the service is carried out by the client terminal, the network platform 50 is designated to be the execution entity, and data representing the network platform 50 is the execution entity of the service program is stored into the service program data storage 5203 (step S63). Incidentally, at this time, the data concerning the trigger to activate the service program, the designation of the execution entity, and the ID of the client requesting the registration of the service program are stored so as to correspond to the service ID.

FIG. 11 shows an example of data stored in the service program data storage 5203. The data table shown in FIG. 11 includes a column of a service ID, a column of an activation trigger, a column of an ID of a client requesting the registration of the service program, a column of a keeping entity, and a column of an execution entity. That is, the activation trigger, the registered client, the keeping entity (including the keeping site network address) and the execution entity are registered for each service program, and are used at the time of actual trigger detection. Incidentally, with respect to the registration client, a person authorized to execute the service program may be registered.

On the other hand, in the case where it is judged that the detection of the trigger of the service is carried out by the client terminal, it is judged whether the service program relates to plural client terminals (step S53). The case where the service program relates to the plural client terminals includes, for example, a case where the client terminal of the transmission destination of the data is changed according to the context (i.e. state) of the client. In the case where it is judged that the service program relates to the plural client terminals, the network platform 50 is designated to be the execution entity, and data representing the network platform 50 is the execution entity of the service program is registered into the service program data storage 5203 (step S63).

On the other hand, in the case where it is judged that the service program relates to only single client terminal, the workload analyzer 5037 analyzes the received service program, calculates (e.g. estimates) the workload of the service program, and stores it into the storage device such as, for example, the main memory (step S55). Here, as for the workload of the service program in this embodiment, a value is used, which is obtained by weighting and adding the number Ni of steps in the service program (for example, the number of steps at the assembler language level, however, in the case where the service program is described in language in which the compilation is not carried out, there is also a case where it is the number of steps in the language), the number Ns of state transitions, and the number Nf of kinds of function modules to be used. For example, when the workload is expressed by a function of f(Ni, Ns, Nf), it is expressed as f(Ni, Ns, Nf)=aNi+bNs+cNf. Incidentally, assuming that Ni is a dominant element, the coefficients are determined. As for b and c, there is a case of b=c=0. The workload analyzer 5037 analyzes the service program, and as described above, counts the number Ni of steps of the service program, the number Ns of state transitions and the number Nf of kinds, calculates the workload f(Ni, Ns, Nf) in accordance with the foregoing expression, and stores it into the storage device. Then, the workload analyzer 5037 outputs the data of the calculated workload f(Ni, Ns, Nf) to the execution entity determination unit 5035.

The execution entity determination unit 5035 refers to the processor capability DB 5036, and reads out the data of the processor power Pp of the client terminal. The type of the client terminal may be specified from the terminal ID included in the packet (for example, the type code is included in the terminal ID), or there is also a case where the terminal type data is separately included in the packet transmitted at the step S25. Then, the execution entity determination unit 5035 uses the processor power expressing the performance of the client terminal and the workload of the service program to calculate no-load performance Pu of the client terminal, and stores it into the storage device (step S57). The no-load performance Pu indicates what amount of work can be processed in a unit time under the condition that there is no other program being executed in the client terminal, and only the service program is executed. That is, Pu=Pp/f(Ni, Ns, Nf) is calculated and is stored into the storage device.

The execution entity determination unit 5035 judges whether the no-load performance Pu of the client terminal is equal to a predetermined threshold J1 or more (step S59). In the case where it is judged that the no-load performance Pu of the client terminal is equal to the predetermined threshold J1 or more, the client terminal is designated to be the execution entity, and data representing the client terminal is the execution entity of the service program is stored into the service program storage 5203 (step S61).

As stated above, the execution entity is determined in accordance with the detection place of the trigger and the relation between the client terminal and the service program. At the time of registration of the service program, because the state of the client terminal at the time when the trigger is actually detected is not known, the execution entity is determined according to the judgment reference as described above, so that the execution entity is optimized at the time of registration of the service program.

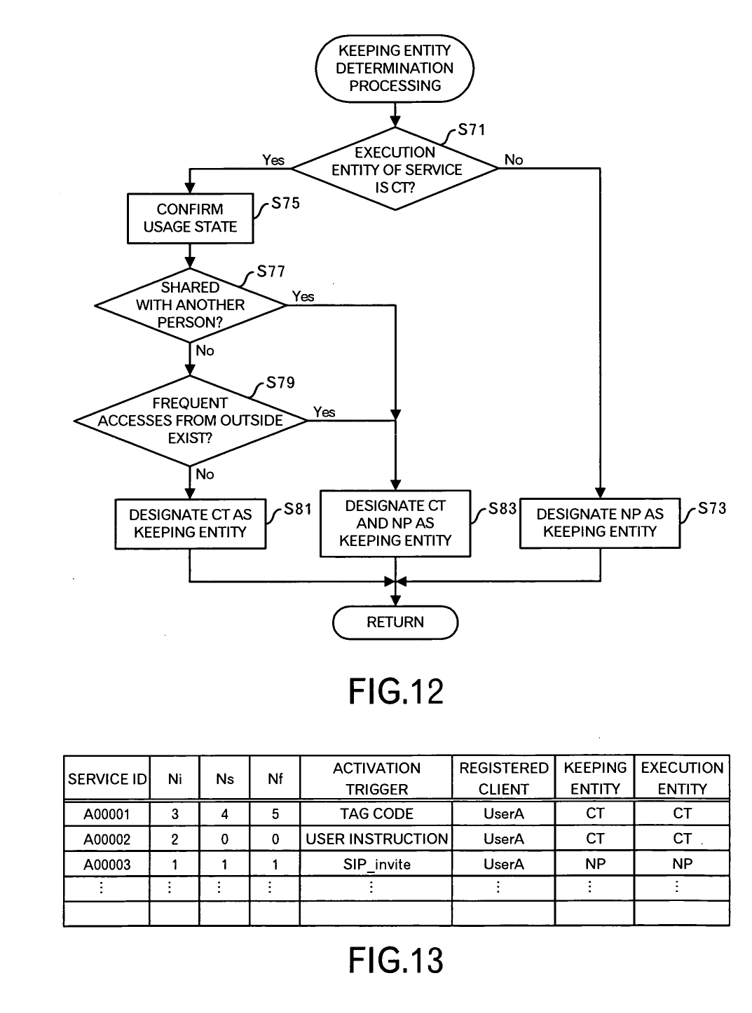

Returning to the explanation of FIG. 7, next, the keeping entity determination unit 5034 carries out a keeping entity determination processing (step S39). The keeping entity determination processing will be described with reference to FIG. 12. Basically, when the service program is stored in the same place as the service execution entity, because it is not necessary to download the service program, this is superior in quickness. Then, the keeping entity determination unit 5034 accesses to the service program data storage 5203, and confirms whether the execution entity of the service program is set to the client terminal (step S71). In the case where the execution entity of the service program is not the client terminal but the network platform 50, the quick execution of the service program becomes possible when the service program is kept in the network platform 50. Thus, it designates the network platform 50 to be the keeping site, and stores data representing the network platform 50 is the keeping site into the service program data storage 5203 (step S73). Further, it also stores the service program itself into the service program data storage 5203.

On the other hand, in the case where the execution entity of the service program is the client terminal, it inquires the usage state to the client (step S75). When the network platform 50 carries out the keeping entity determination processing, it transmits data to cause the client terminal to display questions “whether this service program is shared with another person?” and “whether accesses to the network platform 50 are frequently performed from the place where you have gone?” and to prompt the client to make an answer. The client terminal receives the data, displays it on the display device, and asks the client for an answer. The client answers to the questions as set forth above by “Yes” or “No”, and the client terminal sends back the answer data to the network platform 50.

The keeping entity determination unit 5034 receives the answer data from the client terminal, and stores it into the storage device. Then, the processing subsequent to step S77 is performed. That is, on the basis of the answer data, it judges whether the service program is shared with another person (step S77). When the answer is such that the service program is shared with another person, it designates the network platform 50 and the client terminal to be the keeping site, and stores data representing the network platform 50 and the client terminal are the keeping entity into the service program data storage 5203 (step S83). Incidentally, in the case where the client terminal is designated to be the keeping site, the network address of the client terminal is also registered. This is because there is also a case where download must be performed from the client terminal in some cases. The service program itself is also stored in the service program data storage 5203.

On the other hand, when the answer is such that the service program is not shared with another person, on the basis of the answer data, it judges whether the client frequently access the network platform 50 from the place where the person has gone (step S79). When the answer is such that the access to the network platform 50 is frequently performed from the place where the person has gone, it designates the network platform 50 and the client terminal to be the keeping site, and stores data representing the network platform 50 and the client terminal into the service program data storage 5203 (step S83). Further, the service program itself is also stored in the service program data storage 5203. On the other hand, when the answer is such that access to the network platform 50 is not frequently performed from the place where the person has gone, it designates the client terminal to be the keeping site, and stores data representing the client terminal is the keeping site into the service program data storage 5203 (step S81).

As stated above, the keeping site is determined according to the execution entity of the service program, so that the quick execution becomes possible, and the highly efficient service processing becomes possible. Further, by determining the keeping site in view of the supposed usage state, convenience is improved. For example, in the case where plural persons share the service program, when the service program is kept in the network platform 50, as compared with the case where it is stored in only a certain terminal, its download becomes easy. Besides, also in the case where the service program is frequently used from the place where the person has gone, when the service program is kept in the network platform 50, it is easily downloaded, and the service program can be executed at that place.

Returning to the explanation of the processing of FIG. 7, the CT management function module 503 accesses to the service program data storage 5203, generates a registration completion notice including the designation of an execution entity (NP or CT), the designation of a keeping entity (CT/NP/CT and NP) and a service ID, and transmits it to the client terminal 7 (step S41).

The service program development unit 701 of the management program 71 in the client terminal 7 receives the registration completion notice including the designation of the execution entity, the designation of the keeping entity, and the service ID from the network platform 50 (step S43), and stores the designation data of the service ID, the execution entity, and the keeping entity into the service program data storage 717 (step S45). FIG. 13 shows an example of data stored in the service program data storage 717. The data table of FIG. 13 includes a column of a service ID, a column of the number Ni of steps in the service program, a column of the number Ns of state transitions in the service program, a column of the number Nf of usage function modules in the service program, a column of an activation trigger, a column of a registered client, a column of a keeping entity, and a column of an execution entity. The service program development unit 701 registers the received service ID and designation data of the execution entity and the keeping entity into the column of the service ID, the column of the keeping entity, and the column of the execution entity. Incidentally, in the case where the execution entity is the client terminal, at this stage, the service program development unit 701 may cause the workload analyzer 702 to analyze the service program, and to count Ni, Ns and Nf, and they may be stored into the service program data storage 717. This is because it becomes unnecessary to analyze the service program at the time when a trigger occurs, if such a processing is done. Further, in the case where the execution entity is the client terminal, the service program development unit 701 analyzes the service program, and registers the activation trigger of the service program and the registered client ID into the column of the activation trigger and the column of the registered client.

Then, in the case where the client terminal is designated to be the keeping site, the service program development unit 701 stores the registered service program into the service program data storage 717 in accordance with the data of the keeping entity stored in the service program data storage 717 (step S47).

The execution preparation of the service program is completed by performing the processing as described above. Incidentally, in the case where the execution entity is determined in the network platform 50, because the workload (f(Ni, Ns, Nf)) is not calculated in the client terminal 7, for example, after the step S45, the workload analyzer 702 may calculate the workload (f(Ni, Ns, Nf)) and may store it into the service program data storage 717. This is because when a trigger occurs, it becomes unnecessary to analyze the service program, if such a processing is done.

In the foregoing example, although the example has been described in which the determination of the execution entity and the keeping entity, and the issuance of the service ID are carried out in the network platform 50, this must not be always performed in the network platform 50.

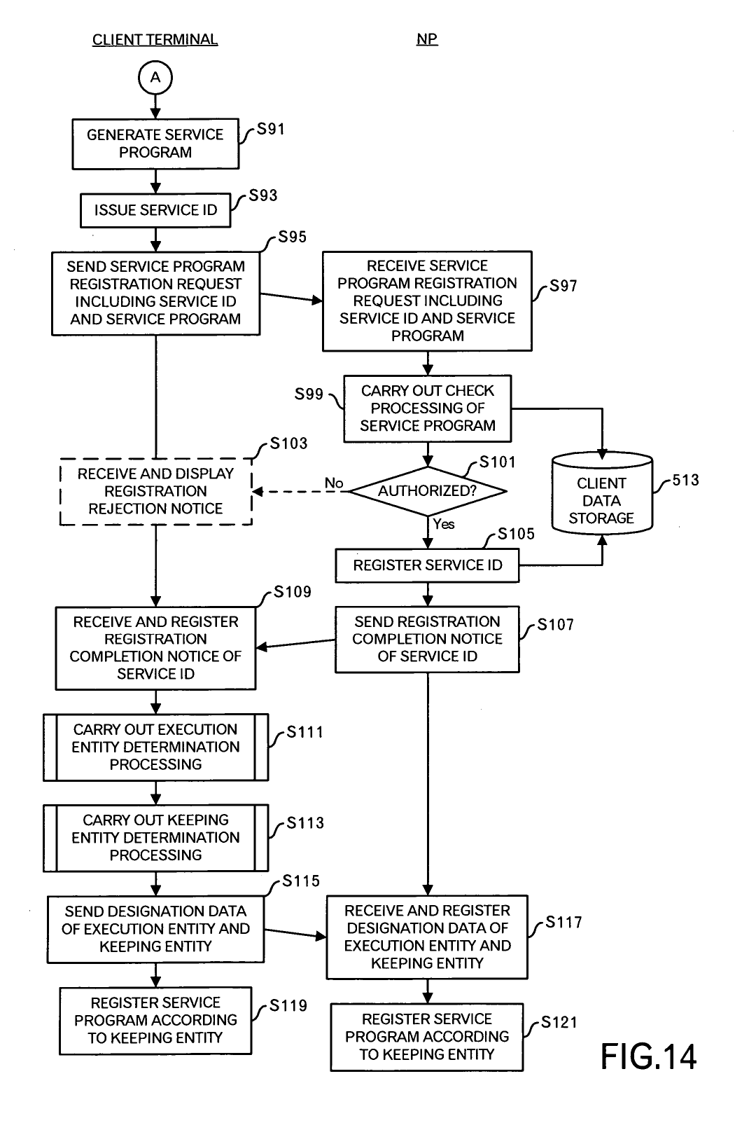

Next, a description will be given to a case where the determination of an execution entity and a keeping entity of a service program, and the issuance of a service ID are carried out in the client terminal. Incidentally, because the processing shown in FIG. 5 is the same, a processing subsequent to the terminal A will be described with reference to FIG. 14.

The service program development unit 701 of the management program 71 in the client terminal 7 generates the service program in accordance with the received input data, and stores it into the storage device (step S91). The service program development unit 701 of the management program 71 causes the service ID manager 705 to issue the service ID of the service program (step S93). The service ID manager 705 stores the issued service ID into the storage device. Then, the service program development unit 701 transmits a service program registration request including the issued service ID and the generated service program to the network platform 50 (step S95). The service program check unit 5031 of the CT management function module 503 in the network platform 50 receives the service program registration request including the service ID and the service program from the client terminal 7 and stores it into the storage device (step S97). Then, the service program check unit 5031 of the CT management function module 503 refers to the client data storage 513 to carry out a check processing to the received service program (step S99).

For example, data as shown in FIG. 8 is stored in the client data storage 513. The service program check unit 5031 of the CT management function module 503 uses the client ID included in the service program registration request to search the table as shown in FIG. 8, identifies the IDs of authorized function modules, and judges whether all function modules defined in the service program can be used, that is, the usage of the service program can be authorized (step S101).

In the case where an unauthorized function module is defined in the service program, the service program check unit 5031 of the CT management function module 503 transmits a registration rejection notice to the client terminal 7. The service program development unit 701 of the management program 71 in the client terminal 7 receives the registration rejection notice, and displays it on the display device (step S103). By doing so, it is possible to recognize that there is a problem in the generated service program.

On the other hand, in the case where it is judged that all the function modules defined in the service program received from the client terminal 7 are authorized, the service ID manager 5033 of the CT management function module 503 registers the service ID of the received service program into the client data storage 513 and the service program data storage 5203 (step S105). For example, as shown in FIG. 9, the service ID is registered correspondingly to the client ID. Besides, the service ID manager 5033 generates a record in the data table shown in FIG. 11, and registers the service ID. Incidentally, the service program itself or an ID group of all the defined function modules may be registered so as to correspond to the client ID into the client data storage 513 or another data storage for authentication and authorization.

The service program check unit 5031 generates a registration completion notice of the service ID, and transmits it to the client terminal 7 (step S107). The service program development unit 701 of the client terminal 7 receives the registration completion notice of the service ID from the network platform 50, and registers it into the service program data storage 717 (step S109). The data to be registered in the service program data storage 717 is the data as shown in FIG. 13, and here, the service ID and registered client ID are registered.

Next, the service program development unit 701 causes the first execution entity determination unit 704 to carry out an execution entity determination processing (step S111). The execution entity determination processing by the first execution entity determination unit 704 is basically similar to the processing shown in FIG. 10. However, in the case of the step S111, it is performed using the service program data storage 717, the first execution entity determination unit 704, the workload analyzer 702, and the processor capability DB 719. Then, the data to be stored in the service program data storage 717 is the data as shown in FIG. 13, and Ni, Ns, Nf, the activation trigger, and the execution entity are registered at the execution entity determination processing of the step S111.

Further, the keeping entity determination unit 703 carries out a keeping entity determination processing (step S113). Although the keeping entity determination processing by the keeping entity determination unit 703 is basically similar to the processing shown in FIG. 12, in the case of the step S113, it is performed by using the service program data storage 717 and the keeping entity determination unit 703. The keeping entity determination unit 703 directly asks the client for the usage state. Incidentally, in the keeping entity determination processing at step S113, the keeping entity is registered in the service program data storage 717.

Then, the service program development unit 701 accesses to the service program data storage 717, and transmits the designation data of the execution entity and the keeping entity to the network platform 50 (step S115). Incidentally, the service ID is transmitted, so that the service program is identified. The CT management function module 503 in the network platform 50 receives the designation data of the execution entity and the keeping entity, and registers it into the service program data storage 5203 correspondingly to the received service ID (step S117). When the keeping entity is the network platform 50, the CT management function module 503 stores the service program received at the step S97 and stored in the storage device into the service program data storage 5203 on the basis of the designation data of the keeping entity (step S121).

On the other hand, when the keeping entity is the client terminal, the keeping entity determination unit 703 of the management program 71 in the client terminal 7 stores the service program generated at the step S91 and stored in the storage device into the service program data storage 717 on the basis of the designation data of the keeping entity (step S119).

Even if the processing as shown in FIG. 7 is replaced with the processing as stated above, the execution preparation of the service program can be carried out.

As a result, when the service is requested to the network platform 50 through the SCI, the packet as shown in FIG. 2B can be generated and transmitted, and the service defined in the service program customized by the user can be received from the network platform 50.

Incidentally, in the processing flow of FIG. 5, the function module for the client terminal is downloaded at the steps S11 to S19 if necessary. However, for example, after the client terminal receives the registration completion notice, the function module necessary for execution of the service program may be further downloaded. Besides, it is possible that the steps S11 to S19 are not carried out, and the function module necessary for execution of the service program is downloaded after the registration completion notice is received.

[Execution Processing of Service Program]

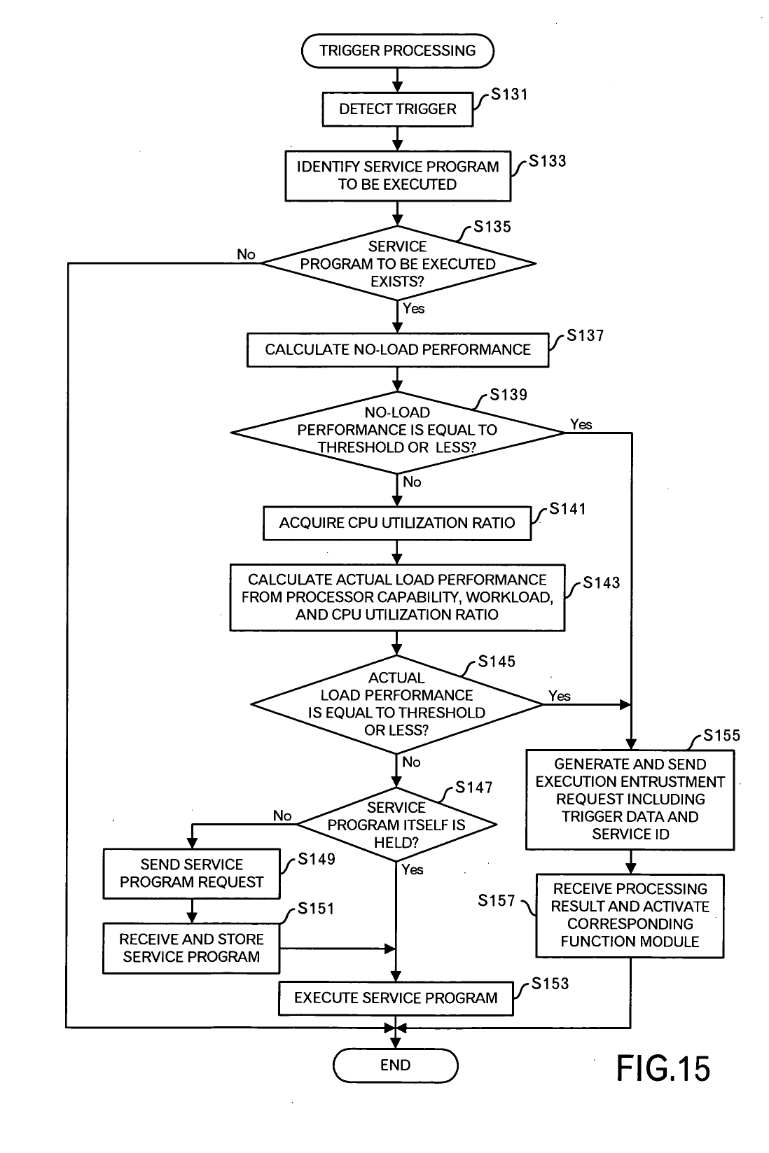

Next, a case where a trigger is detected in the client terminal and a processing is started will be described with reference to FIG. 15. The trigger detector 711 of the service program execution processor 710 in the client terminal 7 makes a search for the occurrence of an event as a trigger, and when any trigger occurs, it acquires the data of the trigger (step S131). The trigger detector 711 outputs the data of the trigger to the service program specifying unit 712. The service program specifying unit 712 accesses to the service program data storage 717, and specifies the service program to be executed (step S133). For example, the column of the activation trigger in FIG. 13 is searched, and it is judged whether the service program corresponding to the detected trigger is registered (step S135) Incidentally, it may be further confirmed whether the client using the client terminal 7 presently is the registered client (i.e. authorized client).

Here, in the case where it is judged that the service program corresponding to the detected trigger and to be executed is not registered, the processing is ended. On the other hand, in the case where it is judged that the service program to be executed is registered, the second execution entity determination unit 713 searches the processor capability DB 719 to read the processor power of the client terminal, reads out the number Ni of steps, the number Ns of state transitions and the number Nf of used function modules in the service program to be executed from the service program data storage 717, calculates the no-load performance according to the method as described above, and stores it into the storage device (step S137). In the case where Ni, Ns and Nf have not been counted, it may cause the workload analyzer 702 to count, and may cause the second execution entity determination unit 713 to calculate the no-load performance. Although a value of the no-load performance is not registered in FIG. 13, for example, a value calculated at the time of registration of the service program may be registered, and the value may be read out at the step S137. Then, it judges whether the no-load performance is equal to a predetermined threshold or less (step S139).

In the case where it is judged that the no-load performance is equal to the predetermined threshold or less, when the service program is made to be executed in the client terminal 7, there is a possibility that satisfactory performance can not be obtained, for example, a bad influence is given on the normal operation of the client terminal 7, or it takes much time to perform the processing. Thus, at the service program registration stage, the execution is entrusted to the network platform 50. Accordingly, the second execution entity determination unit 713 causes the execution entrusting processor 718 to perform an execution entrustment processing to the network platform 50. That is, the execution entrusting processor 718 generates an execution entrustment request including the data of the detected trigger and the service ID of the service program to be executed, and transmits it to the network platform 50 (step S155).

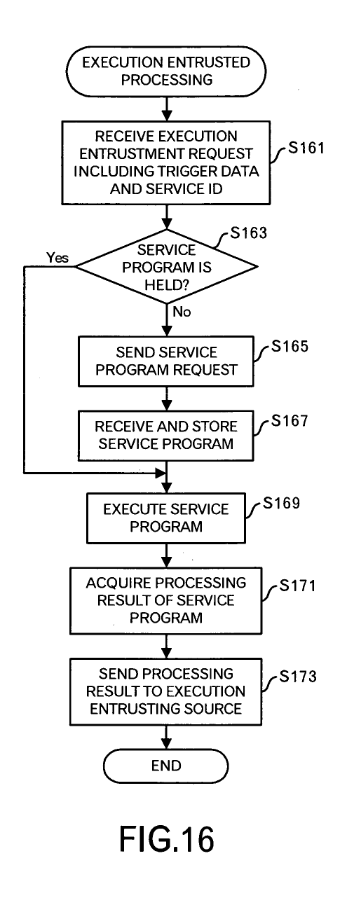

The processing subsequent to this will be described with reference to FIG. 16. The execution entrusted processor 5204 of the service program execution processor 520 in the network platform 50 receives the execution entrustment request including the data of the trigger and the service ID of the service program to be executed (step S161). The execution entrusted processor 5204 accesses to the service program data storage 5203, and confirms whether the service program specified by the service ID is held (step S163). When held, the processing proceeds to step S169. On the other hand, in the case where it is judged that the service program is not held, it accesses to the service program data storage 5203, specifies the keeping site of the service program from the data (i.e. network address of the client terminal holding the service program) of the keeping entity of the service program, and transmits a service program request including the service ID to the service program keeping site (step S165). In the case where the client terminal 7 is the keeping site, the management program 71 reads out the data of the service program corresponding to the service ID from the service program data storage 717, and transmits it to the network platform 50. The execution entrusted processor 5204 of the network platform 50 receives the service program, and stores it into the service program data storage 5203 (step S167).

In the case where it is judged after the step S167 or at the step S163 that the service program is held, the execution entrusted processor 5204 causes the service program, the execution of which is entrusted, to be executed (step S169). The service program uses the function modules provided in the network platform 50 to perform the execution, and outputs the processing result of the service program to the execution entrusted processor 5204. The execution entrusted processor 5204 acquires the processing result of the service program (step S171), and transmits the processing result to the client terminal 7 of the execution entrusting source (step S173). Then, the processing returns to the original processing.

As stated above, since the processing of the service program is not performed in the client terminal but can be executed by the network platform 50, the network service can be received without raising the processing load of the client terminal.

Returning to the explanation of FIG. 15, the execution entrusting processor 718 receives the processing result of the service program from the network platform 50, and if necessary, activates the corresponding function modules (step S157). For example, in the case where the processing result is received in an HTML format, it activates a Web browser to display the processing result. When the processing result is in a mail format, it activates a mail client program to display the mail. In addition, the execution entrusting processor 718 itself may cause the processing result to be displayed.

On the other hand, in the case where it is judged at the step S139 that the no-load performance exceeds the predetermined threshold, the second execution entity determination unit 713 causes the CPU utilization ratio acquiring unit 715 to acquire the CPU activity ratio from the OS or the like, and stores it into the CPU utilization ratio storage 716 (step S141). Thereafter, the second execution entity determination unit 713 accesses to the CPU utilization ratio storage 716, the service program data storage 717, and the processor capability DB 719, acquires the CPU utilization ratio, the processor capability (i.e. power) and the data (Ni, Ns, and Nf) as the basis of the calculation of the workload, calculates actual load performance, and stores it into the storage device (step S143). Here, other jobs already executed in the client terminal are taken into consideration, and the influence of the execution of the service program must be analyzed on the basis of the remaining power of the processor. Accordingly, first, the processor remaining power Pr is defined as Pr=processor power Pp×(1−CPU utilization ratio). The actual load performance P1 of the client terminal is defined as Pr/f(Ni, Ns, Nf)=Pr/(aNi+bNs+cNf).

The second execution entity determination unit 713 judges whether the actual load performance P1 is equal to a predetermined threshold or less (there is also a case where it is different from the threshold at step S139) (step S145). In the case where it is judged that the actual load performance P1 is equal to the predetermined threshold or less, the processing proceeds to the step S155, and the execution of the service program is entrusted to the network platform 50. On the other hand, in the case where it is judged that the actual load performance P1 exceeds the predetermined threshold, the second execution entity determination unit 713 accesses to the service program data storage 717, and judges whether the service program to be executed is held (step S147). In the case where it is judged that the service program is not held, the second execution entity determination unit 713 causes the download unit 714 to transmit a service program request including the service ID of the service program to be executed to the network platform 50 (step S149).

When receiving the service program request from the client terminal, the CT management function module 503 of the network platform 50 reads out the service program from the service program data storage 5203, and sends back it to the client terminal as the requester. On the other hand, the download unit 714 receives the service program from the network platform 50, and stores it into the service program data storage 717 (step S151). The second execution entity determination unit 713 or the download unit 714 causes the service program to be executed (step S153). Thereafter, the service program is normally executed.

When the condition as described above is satisfied, the service program can be executed in the client terminal quickly and suitably. Besides, also in the case where the condition is not satisfied, because the execution can be entrusted to the network platform 50, the client can receive the network service, even if there is no remaining processing in the client terminal.

Incidentally, in the case where the client uses a client terminal, which is not usually used, and instructs to execute a specific service program, there is also a case where the data of the specific service program is not registered in the service program data storage 717 of the client terminal. However, in such a case, because the service program is designated by the user, the processing proceeds from the step S135 to the step S137.

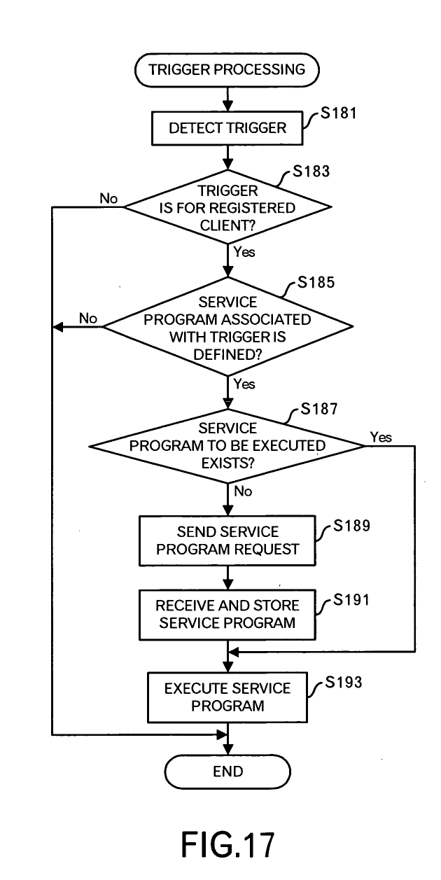

Next, a processing in a case where a trigger is detected in the network platform 50 will be described with reference to FIG. 17. The trigger detector 5201 of the service program execution processor 520 in the network platform 50 makes a search for the occurrence of an event as the trigger, and when any trigger occurs, it acquires the data of the trigger (step S181). Then, the trigger detector 5201 outputs the data of the trigger to the service program specifying unit 5202. The service program specifying unit 5202 accesses to the service program data storage 5203 or the client data storage 513, and judges whether the detected trigger is the trigger for the registered client (step S183). For example, it judges whether the client is the client registered in the column of the registered client in the data table as shown in FIG. 11, or the client registered in the column of the client ID in the data table as shown in FIG. 8 or 9. In the case where it is judged that the detected trigger is not the trigger for the registered client, the processing is ended.

On the other hand, in the case where it is judged that the detected trigger is the trigger for the registered client, the service program specifying unit 5202 accesses to the service program data storage 5203, and judges whether the service program relevant to the detected trigger is defined (step S185). For example, in the data table of FIG. 11, it is judged according to whether the detected trigger is registered in the column of the activation trigger in the data table of FIG. 11. In the case where it is judged that the service program relevant to the detected trigger is not defined, the processing is ended. In the case where the service program relevant to the detected trigger is defined, the service program specifying unit 5202 confirms whether the service program to be executed (which is specified from, for example, the service ID and client ID corresponding to the detected trigger) is held (step S187).

In the case where the service program to be executed is held, the processing proceeds to step S193. On the other hand, in the case where the service program to be executed is not held, the service program specifying unit 5202 causes the download unit to download it. That is, the download unit 5205 specifies the keeping site from the data of the keeping entity stored in the service program data storage 5203, and transmits a service program request to the keeping site (step S189). When the client terminal 7 is the keeping site, the management program 71 of the client terminal 7 reads out the requested service program from the service program data storage 717, and transmits it to the network platform 50. The download unit 5205 receives the service program relating to the request from the client terminal 7, and stores it into the service program data storage 5203 (step S191).

In the case where it is judged at the step S187 that the service program to be executed is held, or after step S191, the service program is executed (step S193). As the need arises, the processing result of the service program is transmitted to the client terminal.

When doing so, the service program can be executed in the network platform 50 quickly and suitably. Incidentally, with respect to the execution entity determination unit 5206, the state of a client terminal or a specific server of the network platform 50 may be again checked to judge whether the service program is to be executed in the client terminal or the specific server. However, in general, with respect to the network platform 50, because the margin in processing power is larger than the client terminal, the processing using the execution entity determination unit 5206 may not be performed.

[Specific Processing Mode of Service Program]

(1) Execution of Service Program in Client Terminal (Case Where there is Client Instruction)

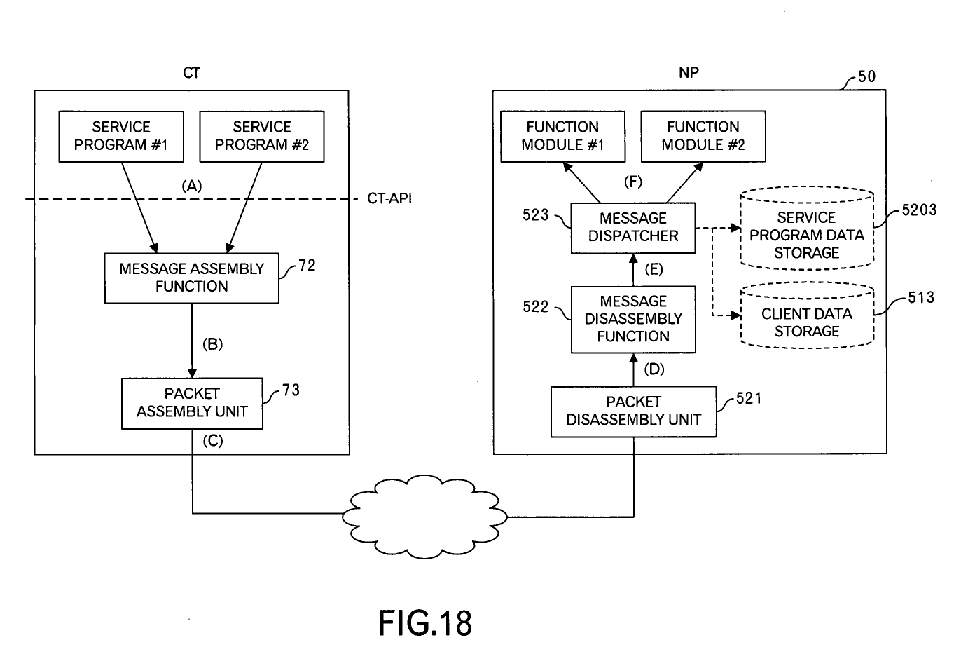

Next, a description will be given to a case where execution of a specific service program is instructed by a client in the client terminal 7, and the specific service program is directly executed in the client terminal 7. Incidentally, the assembly, disassembly and distribution method of a message and a packet, as the premise, will be described first with reference to FIGS. 18 to 20.

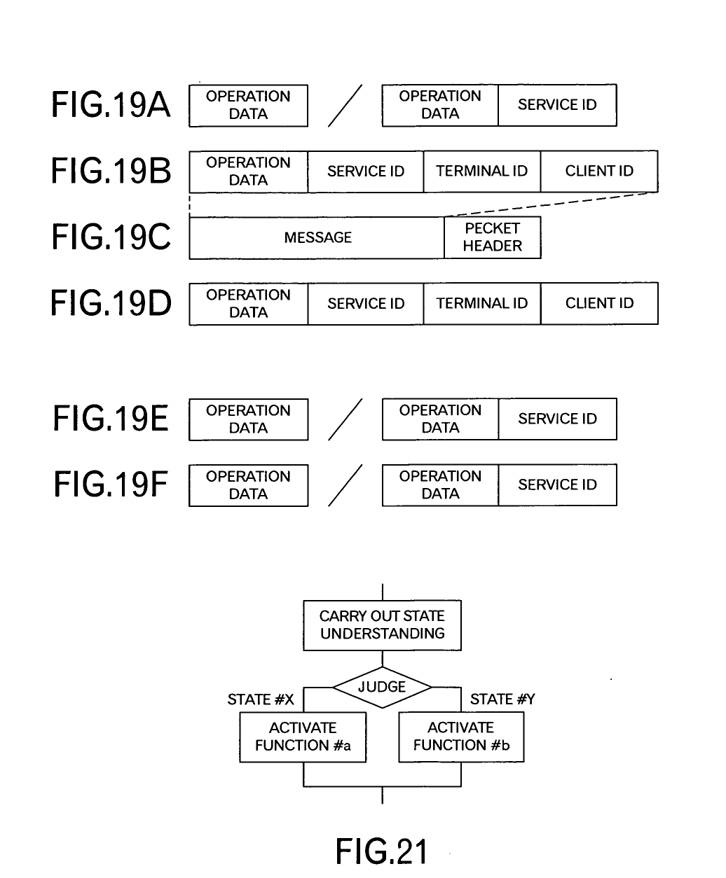

As shown in FIG. 18, when a service program #1 or a service program #2 generates operation data (for example, an activation request of a specific function module and a necessary parameter) the service program #1 or the service program #2 outputs the operation data to a message assembly function module 72. The data outputted to the message assembly function module 72 is data as shown in FIG. 19A. Although the data is basically only the operation data, there is also a case where a service ID, together with the operation data, is outputted in order to distinguish the service program. The message assembly function module 72 further adds a terminal ID and a client ID and outputs them to a packet assembly unit 73. That is, data as shown in FIG. 19B is constructed as a message. Incidentally, an interface between the message assembly function module 72 and the packet assembly unit 73 is a normal communication interface, and the packet assembly unit 73 adds a packet header including, for example, a network address in accordance with a specific communication protocol. Data as shown in FIG. 19C is generated.

Next, in the network platform 50, a packet disassembly unit 521 receives the packet from the client terminal in accordance with the specific communication protocol, extracts a message (operation data, service ID, terminal ID, and client ID) included in the packet, and outputs it to a message disassembly function module 522 through a communication interface. The message is data as shown in FIG. 19D. When receiving the message, the message disassembly function module 522 disassembles the client ID, the terminal ID, the service ID and the operation data, and outputs the client ID, the terminal ID, and the service ID to the authentication and authorization function module 501 and the billing function module 502. Incidentally, for sending back a response, there is also a case where the packet disassembly unit 521 outputs the network address included in the packet header to the message disassembly function module 522, and the message disassembly function module 522 stores the network address into the storage device so as to correspond to the client ID, the terminal ID or the service ID.

The authentication and authorization function module 501 refers to the client data storage 513, and uses the client ID and the service ID to perform the service authorization. Incidentally, like the related art, it is judged by the client ID and the terminal ID whether the network platform 50 can be used, and personal authentication is separately performed by the data such as the client ID and password. The billing function module 502 mainly uses the client ID to carry out the billing processing. Incidentally, there is also a case where the service ID and the like are further used to carry out the billing processing. Then, in the case where the fee varies according to each function to be used, the function used is specified from the service ID, the usage state for each function is specified to carry out the billing. Incidentally, with respect to the terminal ID, since the same ID is given to plural terminals, and it is possible to specify from the terminal ID that a terminal belongs to a specific group, there is also a case where the terminal ID is also used for billing at the time when a certain user group shares terminals. Further, in the case of a public terminal or the like, which is assumed to be used by many and unspecified users, it may be judged by using the terminal ID whether the provision of a service defined by a client is authorized.

Incidentally, the authentication and authorization function module 501 further refers to the client data storage 513, and on the basis of the correspondence between the client ID and the IDs of the authorized function modules as shown in FIG. 8, it may judge whether the function module to be activated, which is designated in the operation data, can be used. At this time, the function module may be specified by the authentication and authorization function module 501, or may be performed by a message dispatcher 523 described below. Alternatively, there is also a case where a judgment is made from, not the data as shown in FIG. 8, but a correspondence between the client ID and the registered service programs or an ID group of all function modules defined in the registered service programs.

When the service authorization by the client ID and the service ID is obtained, as shown in FIGS. 19E and 19F, the message disassembly function module 522 outputs only the operation data or the operation data and the service ID to the message dispatcher 523. The message dispatcher 523 analyzes the operation data, specifies the function module of the output destination, and outputs the operation data to the function module. As shown in FIGS. 19E and 19F, at this time, there is also a case where the message dispatcher 523 adds the service ID and outputs it in order to recognize that the request is from which service program.

Incidentally, the message dispatcher 523 may refer to the client data storage 513 (FIG. 8 and the like), and judge whether the function module to be utilized, which is designated in the operation data, can be used. In addition, although the operation data basically includes designation of the function module to be used (that is, activated), only necessary parameters may be included while the designation of the function module is not included. In such a case, for example, a correspondence between a client ID and a service ID and a service program itself or an ID group of all function modules defined in the service program may be registered in the service program data storage 5203, the state in the service program identified by the client ID and the service ID may be specified by the parameters included in the operation data, and the function module to which the parameters are outputted may be specified according to the state in the service program.

In this way, the request of the service program in the client terminal is transmitted to the suitable function module in the network platform 50.

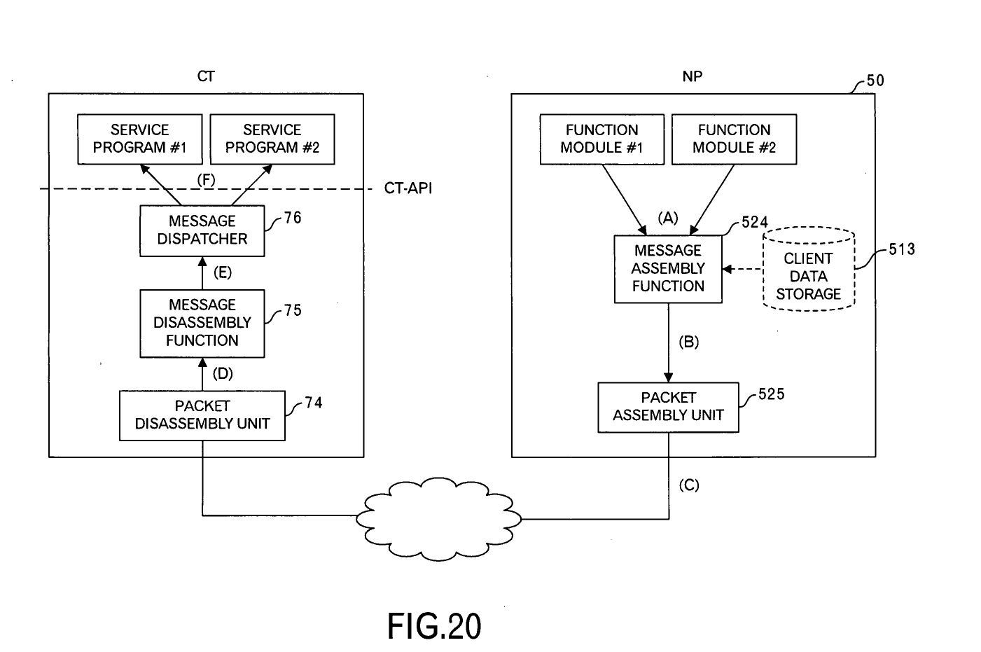

Next, a processing in a case where a response is sent back from the network platform 50 to the client terminal will be described with reference to FIG. 20. First, a function module #1 or a function module #2 in the network platform 50 outputs operation data (i.e. processing result) or operation data and a service ID to a message assembly function module 524. The data to be outputted is the same as that of FIG. 19A. The message assembly function module 524 specifies a requesting client, adds a terminal ID and a client ID to construct a message, and outputs it to a packet assembly unit 525. The constructed message is the data as shown in FIG. 19B. The requesting client is specified in conjunction with the message disassembly function module 522 and the message dispatcher 523 of FIG. 18, or by using the client data storage 513, which stores the data shown in FIG. 9 and the terminal ID and the like associated with the client ID. The packet assembly unit 525 generates a packet including a packet header including a network address corresponding to the client ID or the terminal ID, and transmits it to the client terminal. The packet to be transmitted is similar to that of FIG. 19C.

In the client terminal, when receiving the packet as shown in FIG. 19C, a packet disassembly unit 74 removes the packet header, and outputs a message portion to a message disassembly function module 75. The structure of the message portion is similar to that of FIG. 19D. The message disassembly function module 75 extracts the operation data included in the message, or the operation data and the service ID, and outputs them to a message dispatcher 76. The data outputted at this stage is similar to that of FIG. 19E or 19F. The message dispatcher 76 outputs the operation data or the operation data and the service ID to the service program #1 or the service program #2 in accordance with the analysis result of the operation data or in accordance with the service ID.

By carrying out the processing as stated above, the operation data is suitably exchanged between the client terminal and the network platform. Incidentally, because the network address and the function module are not directly correlated with each other, there is also a merit that it is unnecessary to take the trouble to notify the client terminals of the addition and modification of the function modules in the network platform 50.

Next, on the premise of the assembly, disassembly and distribution method of the message and the packet shown in FIGS. 18 to 20, with reference to FIGS. 21 to 25, a description will be given to a specific processing flow for the message exchange in a case where a client instructs the client terminal 7 to execute a specific service program as described above. Here, it is assumed that for example, in the service program #1 of the client terminal 7, the logic as shown in FIG. 21 is defined. That is, it is assumed that a service program #1 is defined such that, first, as a state understanding for a specific terminal (or user), an inquiry is made to a context management function module #c, a state judgment is made on the basis of a response to the inquiry, and when the state of the specific terminal is a state #X, a function module #a is activated, and when it is a state #Y, a function module #b is activated. Besides, it is assumed that a service ID is #0703, a terminal ID is #936, and a client ID is #531.

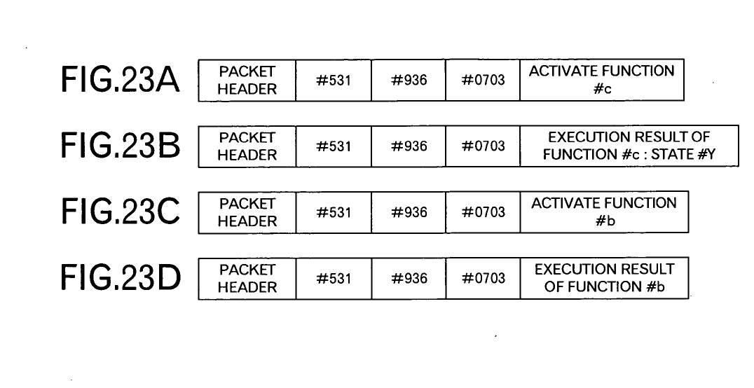

Then, the service program #1 or the like of the client terminal 7 generates a message for an activation request of the function module #c in order to carry out the state understanding for the specific terminal, and stores it into the storage device such as a main memory (step S251). The message for the activation request includes a client ID “#531”, a terminal ID “#936”, a service ID “#0703”, an activation request of the function module #c, and identification information of the specific terminal (or identification information of a specific user). The packet assembly unit 73 of the client terminal 7 generates a packet encapsulating the generated message for the activation request and a destination network address, and transmits it to the network platform 50 (step S253). For example, a packet as shown in FIG. 23A is generated and is transmitted.

On the other hand, the packet disassembly unit 521 of the network platform 50 receives the packet encapsulating the message for the activation request of the function module #c from the client terminal 7, and stores the message into the storage device (step S255). Then, it extracts the message for the activation request of the function module #c from the packet (step S257). Besides, also as described above, the message disassembly function module 522 extracts the client ID, the terminal ID, and the service ID included in the message for the activation request, and outputs them to the authentication and authorization function module 501 and the billing function module 502. The authentication and authorization function module 501 confirms the client ID and the terminal ID, and the billing function module 502 performs a billing processing (step S259). Further, the authentication and authorization function module 501 uses the service ID and the client ID to confirm whether the activation request of the function module #c can be authorized (step S261). In the case where a problem is detected at the step S259 or S261, a message that the requested processing cannot be carried out is sent back to the client terminal 7. On the other hand, in the case where a problem is not detected at the steps S259 and S261, the operation data (here, the activation request of the function module #c and parameters) or the operation data and the service ID are outputted from the message disassembly function module 522 to the message dispatcher 523. The message dispatcher 523 analyzes the operation data, and dispatches the operation data to the function module #c (step S263). Incidentally, in the case of the activation, necessary parameters are transferred to activate the function module.

Although described above, before the function module #c is activated, a judgment may be made as to whether or not the function module #c itself can be used (i.e. activated). In this case, a judgment may be made by referring to the data as shown in FIG. 8, which is stored in the client data storage 513, and further, as described above, a judgment may be made by referring to the correspondence, stored in the service program data storage 5203, between the client ID and the service program itself or the ID group of the function modules defined in the service program.

The function module #c carries out a processing on the basis of the operation data (step S265), generates the operation data including the execution result (here, “function #c execution result: state Y” (for example, user A has a cellular phone and is on a train)), and outputs the operation data or the operation data and the service ID to the message assembly function module 524. The message assembly function module 524 adds the client ID “#531”, the terminal ID “#936” and the service ID “#0703” to generate a message (step S267). The packet assembly unit 525 adds the packet header to the message including the execution result to generate the packet, and transmits it to the client terminal 7 (step S269). The packet transmitted at this step is, for example, a packet as shown in FIG. 23B.

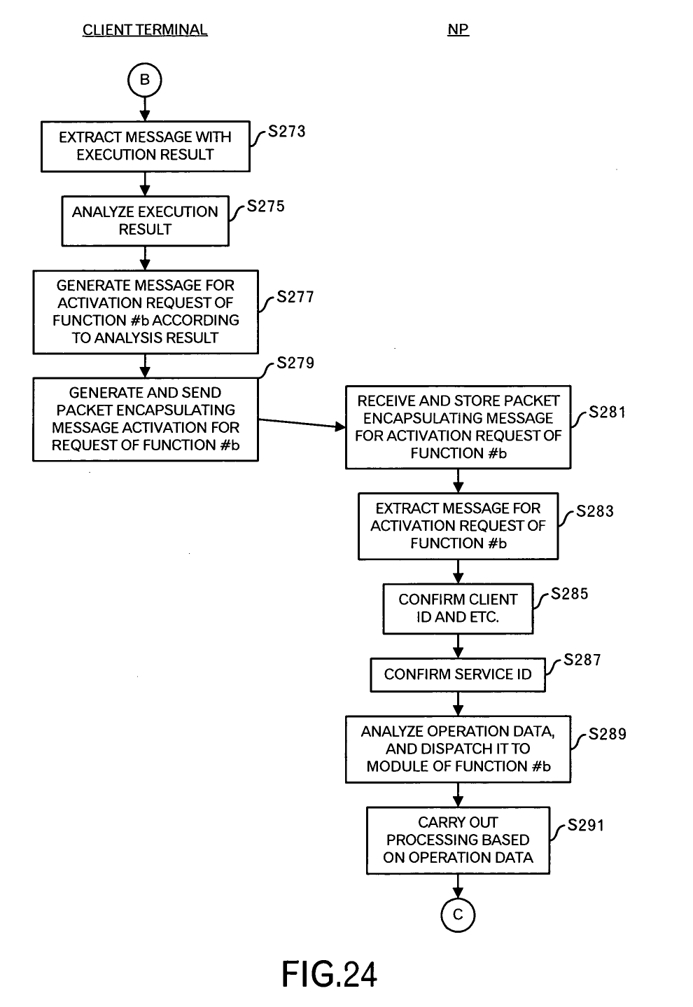

The packet disassembly unit 74 of the client terminal 7 receives the packet including the execution result message from the network platform 50, and stores it into the storage device such as, for example, the main memory (step S271). The processing proceeds to FIG. 24 through a terminal B. Then, the packet disassembly unit 74 extracts the execution result message portion, and outputs it to the message disassembly function module 75 (step S273). The message disassembly function module 75 extracts the operation data including the execution result or the operation data and the service ID from the message including the execution result, and outputs them to the message dispatcher 76. The message dispatcher 76 outputs the operation data to the service program #1 as the requester of the operation data.

The service program #1 analyzes the execution result included in the operation data, and judges the state when it is the service program as shown in FIG. 21 (step S275). In the example of FIG. 23B, because it is understood that the state is the state #Y, the function module #b should be activated. For example, SIP is used to call via VoIP (Voice Over IP). Accordingly, the service program #1 generates an activation request message of the function module #b in accordance with the analysis result (step S277), and stores it into the storage device such as the main memory. The message for the activation request includes the client ID “#531”, the terminal ID “#936”, the service ID “#0703”, the activation request of the function module #b, and a parameter of the calling destination SIP-URL. The packet assembly unit 73 of the client terminal 7 generates a packet encapsulating the generated message for the activation request message and the destination network address, and transmits it to the network platform 50 (step S279). For example, the packet as shown in FIG. 23C is generated and is transmitted.

On the other hand, the packet disassembly unit 521 of the network platform 50 receives the packet encapsulating the message for the activation request of the function module #b from the client terminal 7, and stores the message into the storage device (step S281). Then, it extracts the message for the activation request of the function module #b from the packet (step S283). Besides, also as described above, the message disassembly function module 522 extracts the client ID, the terminal ID, and the service ID included in the message for the activation request, and outputs them to the authentication and authorization function module 501 and the billing function module 502. The authentication and authorization function module 501 confirms the client ID and the terminal ID, and the billing function module 502 carries out the billing processing (step S285). Further, the authentication and authorization function module 501 uses the service ID and the client ID, and confirms whether the activation request of the function module #b can be authorized (step S287). In the case where a problem is detected at the step S285 or S287, a message that the requested processing cannot be carried out is sent back to the client terminal 7. On the other hand, in the case where a problem is not detected at the step S285 and S287, the operation data (here, the activation request of the function module #b and parameters) or the operation data and the service ID are outputted from the message disassembly function module 522 to the message dispatcher 523. The message dispatcher 523 analyzes the operation data, and dispatches the operation data to the function module #b (step S289) Incidentally, in the case of the activation, necessary parameters are transferred to activate the function module #b. Also as described above, a judgment may be made at this state as to whether the function can be activated.

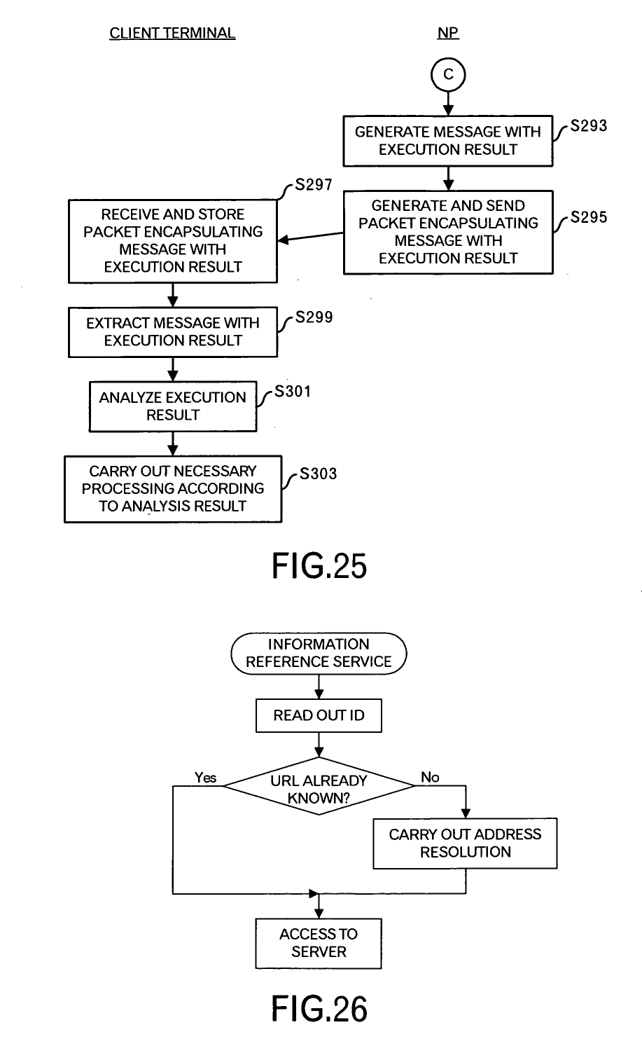

The function module #b carries out the processing on the basis of the operation data (step S291), generates the operation data including the execution result (here, “execution result of the function #b”), and outputs the operation data or the operation data and the service ID to the message assembly function module 524. The processing proceeds to the processing of FIG. 25 through a terminal C.

Then, the message assembly function module 524 adds the client ID “#531”, the terminal ID “#936” and the service ID “#0703” to generate a message (step S293). The packet assembly unit 525 adds a packet header to the message including the execution result to generate a packet, and transmits it to the client terminal 7 (step S295). The packet to be transmitted at this step is, for example, a packet as shown in FIG. 23D.

The packet disassembly unit 74 of the client terminal 7 receives the packet including the execution result message from the network platform 50, and stores it into the storage device such as, for example, the main memory (step S297). Then, the packet disassembly unit 74 extracts the execution result message portion, and outputs it to the message disassembly function module 75 (step S299). The message disassembly function module 75 extracts the operation data including the execution result or the operation data and the service ID from the message including the execution result, and outputs it to the message dispatcher 76. The message dispatcher 76 outputs the operation data to the service program #1 as the requester of the operation data.

The service program #1 analyzes the execution result included in the operation data (step S301), and performs a necessary processing in accordance with the analysis result (step S303).

As stated above, the message added with the service ID is exchanged, and the processing is performed in accordance with the service program.

(2) Execution of Service Program in Client Terminal (without Instruction of Client)

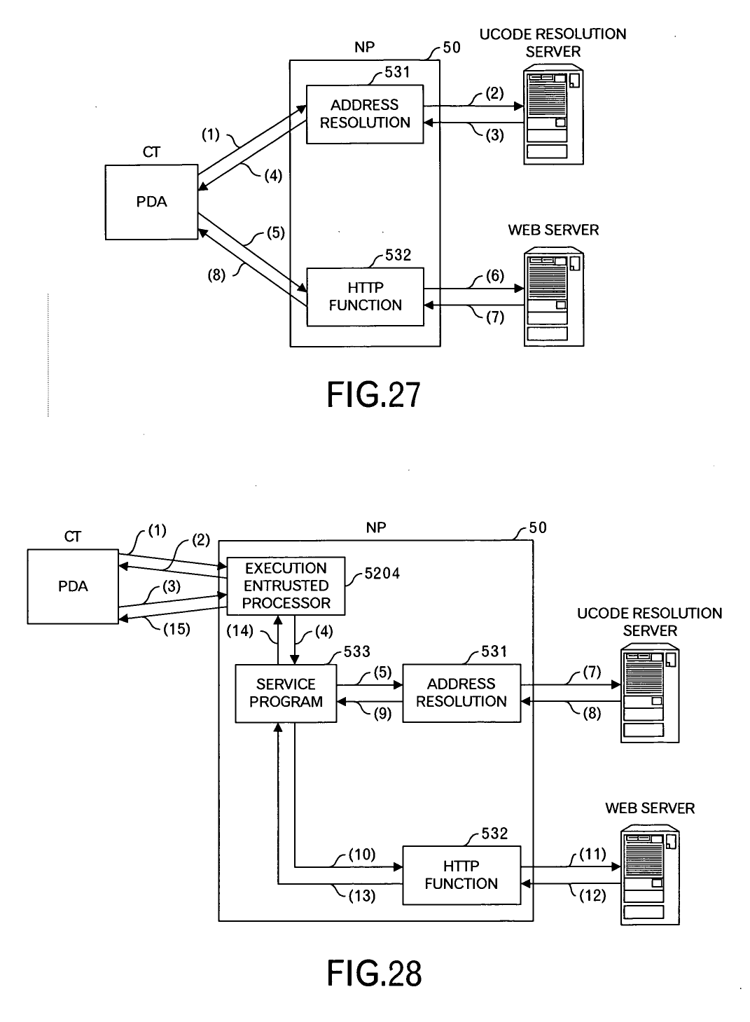

Next, a processing in a case where the service program execution processor 710 is operated so that the service program is executed in the client terminal 7, will be described with reference to FIGS. 26 and 27. Although the processing capability of the processor of a PDA (Personal Digital Assistant) as the client terminal is relatively low, it is assumed that the PDA includes an RFID (Radio Frequency ID, also called an ID tag) reader, and the RFID reader reads an ID so that a service program is executed. The service program is a program including a logic as shown in FIG. 26. That is, first, an ID is read, and it is judged whether a URL (Uniform Resource Locator) corresponding to the ID is already known. In the case where the URL corresponding to the ID is already held, a server access is made. On the other hand, in the case where the URL corresponding to the ID is not held, an address resolution processing is performed, and an acquired address is used to access the server.

Next, a flow of a processing of the whole system will be described with reference to FIG. 27. When the ID is read by the RFID reader of the PDA as the client terminal, the trigger detector 711 of the service program execution processor 710 detects the trigger occurrence, and the service program specifying unit 712 refers to the service program data storage 717 to specify a service program to be executed. Here, it is assumed that the service program as shown in FIG. 26 is specified. When the service program is stored in the service program data storage 717, the service program specifying unit 712 causes the service program to be executed. Here, it is assumed that the URL corresponding to the read ID is unknown. Then, as the address resolution processing in the service program, the service program transmits a message including the read ID and the ID of an address resolution processing module 531 to the network platform 50 (step (1)). The address resolution function module 531 of the network platform 50 receives the ID received from the PDA as the client terminal, and transmits a site search request including the ID to a ucode resolution server. The ucode resolution server searches the URL on the basis of the ID, and sends back a response message including the URL to the network platform 50 (step (3)). The address resolution function module 531 of the network platform 50 receives the response message including the URL from the ucode resolution server, and sends back a message including the URL, as a processing result, to the PDA as the client terminal (step (4)). When receiving the message including the URL from the network platform 50, the service program of the PDA as the client terminal carries out a server access on the basis of the URL. For example, the service program transmits a message including the received URL and an ID of an HTTP (Hyper Text Transfer Protocol) function module 532 to the network platform 50 (step (5)).

The HTTP (Hyper Text Transfer Protocol) function module 532 of the network platform 50 receives the URL from the PDA as the client terminal, and transmits a GET message to a Web server specified by the URL (step (6)). The Web server receives a GET request from the network platform 50, and sends back an HTML file and the like as a response to the GET request to the network platform 50 (step (7)). The HTTP function module 532 of the network platform 50 receives the response including the HTML file from the Web server, and transmits it to the PDA as the client terminal (step (8)). When receiving the response including the HTML file and the like from the network platform 50, the service program of the PDA as the client terminal activates the function module such as the Web browser, and causes the received HTML file and the like to be displayed.

As stated above, in the case where the trigger occurs in the client terminal, the service program is executed in the client terminal, and the provision of the address resolution and the HTTP function can be received as the network service from the network platform 50.

(3) Execution Entrustment of Service Program from Client Terminal to Network Platform

Next, with reference to FIG. 28, a description will be given to a case where because a remaining processing capability of the PDA as the client terminal is insufficient, when an ID is read by an RFID reader of the PDA, a service program to process the read ID cannot be executed in the PDA as the client terminal.

When the RFID reader of the PDA as the client terminal reads the ID, the trigger detector 711 of the service program execution processor 710 detects the occurrence of a trigger, and the service program specifying unit 712 refers to the service program data storage 717 and specifies the service program to be executed. Here, it is assumed that the service program as shown in FIG. 26 is specified. The second execution entity determination unit 713 judges that the actual load performance is equal to a predetermined threshold or less, and activates the execution entrusting processor 718. The execution entrusting processor 718 transmits an execution entrustment request message including data of the detected trigger and the service ID of the service program handling the trigger to the network platform 50 (step (1)).

When receiving the execution entrustment request including the data of the detected trigger and the service ID of the service program from the PDA as the client terminal, the execution entrusted processor 5204 of the service program execution processor 520 in the network platform 50 refers to the service program data storage 5203, and confirms whether the service program specified by the service ID is held. In the case where the service program specified by the service ID is not held, the execution entrusted processor 5204 causes the download unit 5205 to transmit the service program request including the service ID of the service program to be executed to the PDA as the client terminal of the keeping site (step (2)). When receiving the service program request, the management program 71 of the PDA as the client terminal reads out the service program relating to the request from the service program data storage 717, and sends back it to the network platform 50 (step (3)). The download unit 5205 of the service program execution processor 520 in the network platform 50 receives the service program from the PDA as the client terminal. The execution entrusted processor 5204 causes the service program 533 to be executed, and outputs the data of the trigger previously received for the service program 533 to the service program 533 (step (4)).

The service program 533 activates the address resolution function module 531 in accordance with the logic shown in FIG. 26, and outputs the ID of the RFID as the data of the trigger (step (5)). The address resolution function module 531 receives the ID from the service program 533, and transmits a site search request including the ID to the ucode resolution server (step (7)). The ucode resolution server searches the URL on the basis of the received ID, and sends back a response message including the URL to the network platform 50 (step (8)). The address resolution function module 531 of the network platform 50 receives the response message including the URL from the ucode resolution server, and outputs the URL as a processing result to the service program (step (9)). When receiving the URL from the address resolution function module 531, the service program 533 being executed in the network platform 50 carries out the server access on the basis of the URL. For example, the service program 533 activates the HTTP function module 532 is activated, and outputs the received URL (step (10)).

The HTTP function module 532 of the network platform 50 receives the URL, and transmits a GET message to a Web server specified by the URL (step (11)) The Web server receives the GET request from the network platform 50, and sends back an HTML file and the like as a response to the GET request to the network platform 50 (step (12)). The HTTP function module 532 receives the response including the HTML file and the like from the Web server, and outputs it to the service program (step (13)). When receiving the response including the HTML file and the like, the service program 533 being executed in the network platform 50 outputs the response including the HTML file and the like as the processing result to the execution entrusted processor 5204 (step (14)).

The execution entrusted processing 5204 transmits the response of the HTML file and the like as the processing result from the service program to the PDA as the client terminal (step (15)). The execution entrusting processor 718 of the PDA as the client terminal receives the response of the HTML file and the like as the processing result, activates the function module such as the Web browser, and causes the received HTML file and the like to be displayed.

As stated above, even in the case where the client terminal such as the PDA does not have a remaining processing capability due to other jobs, the execution can be entrusted to the network platform 50, and the network platform 50 executes the entrusted service program, and can send back the processing result to the client terminal such as the PDA. That is, the processing result similar to the case where the service program is executed in the client terminal can be obtained.

Incidentally, although the configuration is shown in which the URL as the processing result of the address resolution function module 531 is temporarily returned to the service program 533, and the HTTP function module 532 is activated from the service program 533, the transaction may be directly performed between the address resolution function module 531 and the HTTP function module 532 as the function of the address resolution function module 531. The same applies to the case of FIG. 27.

(4) Case Where a Trigger is Detected in the Network Platform 50 and a Service Program is Executed

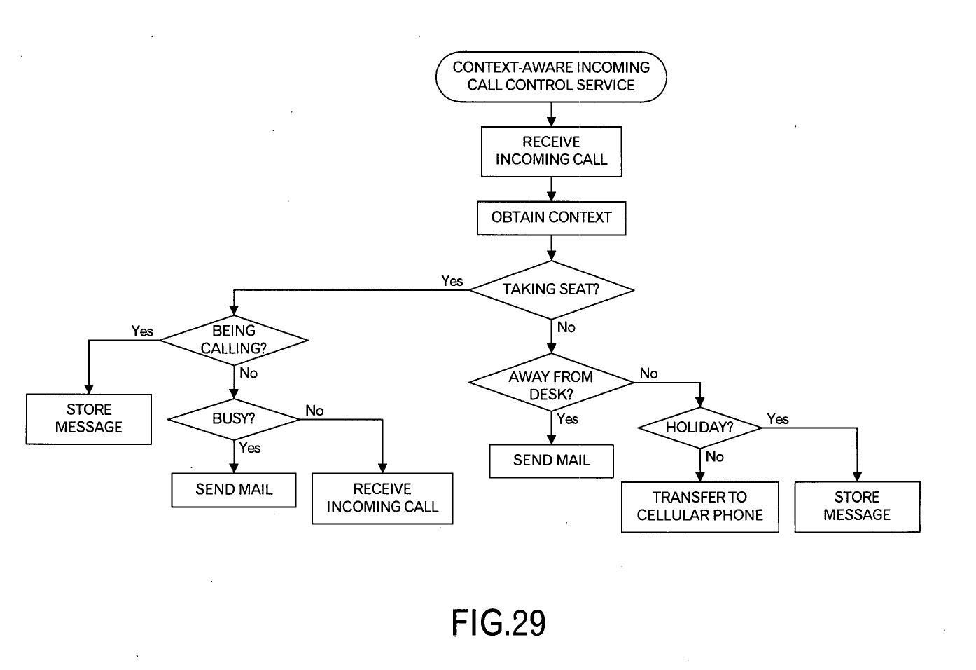

For example, in the case of a service program as shown in FIG. 29, the trigger detector 5201 of the service program execution processor 520 in the network platform 50 detects an incoming call as a trigger, and the service program specifying unit 5202 causes the service program to be executed.

In the example of FIG. 29, in response to an incoming call to a specific client, a context acquisition (i.e. state acquisition) processing on the specific client is performed. As a result, when the specific client is taking his or her seat in the office and is talking, a telephone answering machine function module or the like is made to carry out a message storage processing. On the other hand, the specific client is taking his or her seat in the office and is busy, a mail sending function module or the like is made to carry out a mail sending processing. Further, in the case where the specific client is taking his or her seat in the office and is not busy, in order to make an incoming call arrive at a telephone of the specific client, for example, an SIP function module is made to carry out a processing. On the other hand, in the case where the specific client is not taking his or her seat in the office and is away from the desk, the mail sending function module is made to carry out the mail sending processing. When the specific client is not taking his or her seat in the office but is out (not temporarily away from the desk) and today is a holiday, the telephone answering machine function module is made to carry out the storage processing of a message. On the other hand, when the specific client is not taking his or her seat in the office but is out, and today is a weekday, a transfer function module or the like is made to transfer an incoming call to a predetermined cellular phone of the specific client.

In such a case, in the network platform 50, the processing of the service program is completed, and in the client terminal of the specific client, the function module held irrespective of the service program is used to receive the provision of the network service.

As stated above, various APIs are prepared for the provision of network services, and the user of the client terminal or the software developer can generate a service program in which the function modules are combined to use as the need arises. Further, in the case where a specific service is used, it is sufficient if only the service program is prepared. Thus, as compared with a case where the whole of the specific service is systemized, the number of development steps and the period can be decreased. Besides, the update of the service program itself is easy, and when the function module at the network platform 50 side is updated, all clients can use the improved function. Further, because the function module can be downloaded to the client terminal as the need arises, even in the terminal not having many functions originally, various and high-level services can be used.

Besides, the execution entity of the service program is set to the client terminal or the network platform 50 from the relationship between the service program and the client terminal at the time of registration (i.e. definition) of the service program. However, at the time of execution of the service program, it is confirmed again whether the service program can be executed without badly influencing other jobs or the like, and the execution entity is further determined. Thus, the service program can be suitably executed. Besides, the keeping entity is also determined according to the detection place of the trigger, and the usage state of the client terminal or the service program, the flexible and suitable execution become possible.

Incidentally, in the case where the client uses plural client terminals, the service program to be used is kept in a predetermined storage of the network platform 50, and by an instruction of the client, the service program may be made to be executed after it is downloaded to the client terminal currently being used.

Although the embodiment of the invention has been described, the invention is not limited to this. For example, although the generation processing of the service program through the SMI has been described, when the details of function modules provided in the network platform 50 can be separately obtained, the service program may be generated on the basis of the separately obtained information. Besides, also with respect to the registration of the service program, there is also a case where a procedure of separately performing confirmation and registration without using the network is adopted.

Besides, there is also a case where the network platform 50 is not realized by one computer, and the functions are shared by plural computers, or parallel or distributed processing is carried out for portion of the functions.

Besides, with respect to the service authorization, there is also a case where other data (for example, data (hash value or electronic certificate) to prove that alteration of the service program is not made) is added to confirm it in the network platform 50.

Further, clients who can use a function module may be defined for each of the functional modules in the network platform 50, and by using the client ID and the function module ID included in the operation data, a judgment may be made for each of the function modules as to whether or not the function module can be used. Besides, by using only the corresponding table between the client ID and the function module ID as shown in FIG. 8, a judgment may be made as to whether or not the function module can be used.

Further, the functional block diagrams shown in FIGS. 3 and 4 are examples, and there is also a case where they do not correspond to actual program modules.

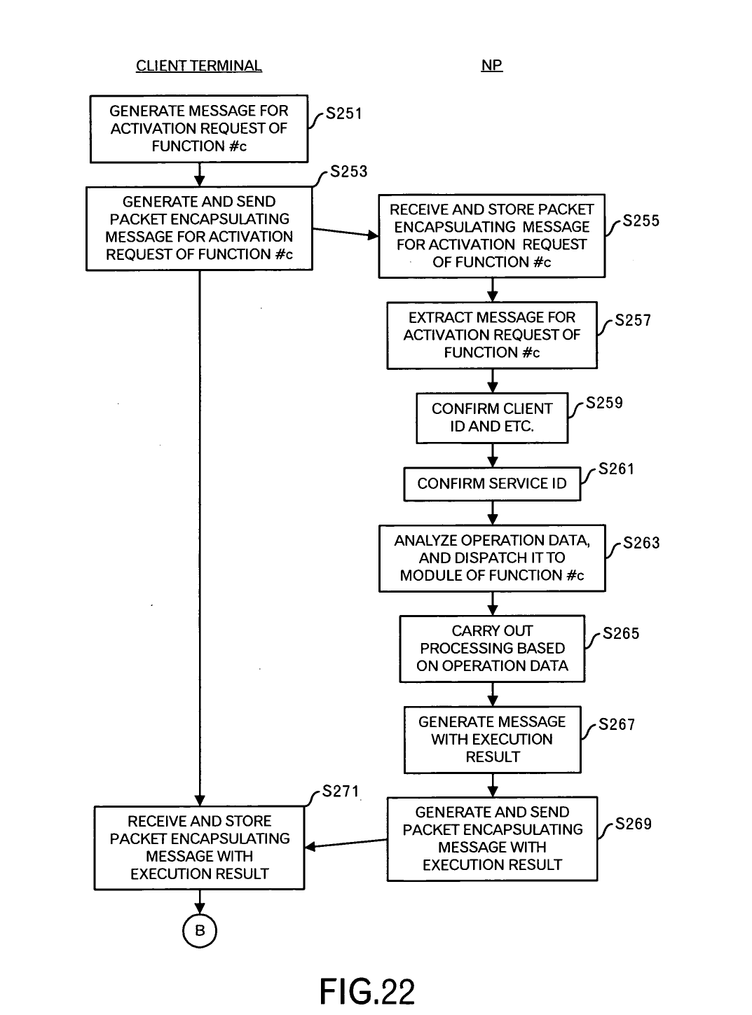

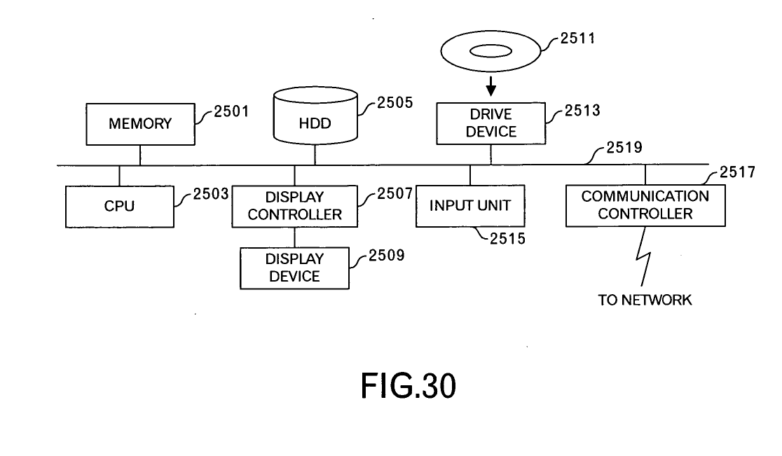

Incidentally, one or plural computers to achieve the network platform 50 and the client terminal are computer devices shown in FIG. 30. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 22. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. An information processing method relating to a service program in which a combination of functions to be used by a client is defined among functions provided on a network platform side, comprising:
analyzing a service program to judge whether detection of a trigger to activate said service program is performed by said client terminal or said network platform side;
if it is judged that said detection of said trigger to activate said service program is performed by said client terminal, judging whether a condition on a relationship between said service program and said client terminal is satisfied; and
if it is judged that said condition is satisfied, determining an execution entity of said service program to be said client terminal.

2. The information processing method as set forth in claim 1, wherein said condition includes a condition that a processing defined in said service program associated with a single client terminal.

3. The information processing method as set forth in claim 1, wherein said condition includes a condition on a relationship between a processing load caused for said client terminal by said service program and processing capability of said client terminal.

4. The information processing method as set forth in claim 3, wherein said processing capability of said client terminal is processing capability when there is no load.

5. The information processing method as set forth in claim 1, further comprising:
if it is judged that said detection of said trigger to activate said service program is performed by said network platform side or if it is judged that said condition is not satisfied, determining said execution entity of said service program to be said network platform; and
causing said network platform to keep said service program whose execution entity is determined to be said network platform.

6. The information processing method as set forth in claim 1, further comprising:
if said client terminal is determined to be said execution entity of said service program, determining either of only said client terminal and both of said client terminal and said network platform, to be a keeping entity of said service program, according to data concerning an assumed usage environment of said service program.

7. The information processing method as set forth in claim 6, wherein said data concerning said assumed usage environment includes at least either of whether or not said service program is shared and whether or not said service program is used at a plurality of positions.

8. An information processing method relating to a service program that is defined by a client side for a combination of functions whose uses are authorized for said client side, among functions provided by a network platform side, and whose identification information is registered in said network platform side, comprising:
detecting a specific trigger;
identifying a service program corresponding to said specific trigger;
judging whether execution of the identified service program has an influence at a predetermined level or bigger on said client terminal; and
if it is judged that said execution of the identified service program does not have said influence at said predetermined level or bigger on said client terminal, causing the identified service program to be executed.

9. The information processing method as set forth in claim 8, further comprising:
if it is judged that the identified service program has said influence at said predetermined level or bigger on said client terminal, transmitting an execution request including data concerning said specific trigger and identification information of said service program to said network platform; and
receiving a processing result of said service program from said network platform.

10. The information processing method as set forth in claim 8, further comprising:
if it is judged that said execution of the identified service program does not have said influence at said predetermined level or bigger on said client terminal, judging whether the identified service program is held; and
if it is judged that the identified service program is not held, downloading the identified service program from said network platform.

11. The information processing method as set forth in claim 8, wherein said judging comprises: judging whether or not a relationship between processing load caused for said client terminal by said service program and processing capability of said client terminal is satisfied with a predetermined condition.

12. The information processing method as set forth in claim 11, wherein said processing capability of said client terminal is current remaining processing capability.

13. An information processing method relating to a service program that is defined by a client side for a combination of functions whose uses are authorized for said client side, among functions provided by a network platform side, and whose identification information is registered in said network platform side, comprising:
detecting a trigger;
judging whether the detected trigger can be handled;
if the detected trigger can be handled, specifying a service program corresponding to the detected trigger; and
executing the specified service program.

14. The information processing method as set forth in claim 13, wherein said judging comprises:
judging whether the detected trigger is a trigger relevant to the client being capable of using said network platform; and
if it is judged that the detected trigger is said trigger relevant to the client being capable of using said network platform, confirming whether a service program associated with the detected trigger is defined.

15. A program embodied on a medium, which relates to a service program in which a combination of functions to be used by a client is defined among functions provided on a network platform side, said program comprising:
analyzing a service program to judge whether detection of a trigger to activate said service program is performed by said client terminal or said network platform side;
if it is judged that said detection of said trigger to activate said service program is performed by said client terminal, judging whether a condition on a relationship between said service program and said client terminal is satisfied; and
if it is judged that said condition is satisfied, determining an execution entity of said service program to be said client terminal.

16. A program embodied on a medium, which relates to a service program that is defined by a client side for a combination of functions whose uses are authorized for said client side, among functions provided by a network platform side, and whose identification information is registered in said network platform side, said program comprising:
detecting a specific trigger;
identifying a service program corresponding to said specific trigger;
judging whether execution of the identified service program has an influence at a predetermined level or bigger on said client terminal; and
if it is judged that said execution of the identified service program does not have said influence at said predetermined level or bigger on said client terminal, causing the identified service program to be executed.

17. A program embodied on a medium, which relates to a service program that is defined by a client side for a combination of functions whose uses are authorized for said client side, among functions provided by a network platform side, and whose identification information is registered in said network platform side, said program comprising:
detecting a trigger;
judging whether the detected trigger can be handled;
if the detected trigger can be handled, specifying a service program corresponding to the detected trigger; and
executing the specified service program.

18. An information processing apparatus, which relates to a service program in which a combination of functions to be used by a client is defined among functions provided on a network platform side, comprising:
a unit that analyzes a service program to judge whether detection of a trigger to activate said service program is performed by said client terminal or said network platform side;
a unit that judges whether a condition on a relationship between said service program and said client terminal is satisfied, if it is judged that said detection of said trigger to activate said service program is performed by said client terminal; and
a unit that determines an execution entity of said service program to be said client terminal, if it is judged that said condition is satisfied.

19. A client terminal, which relates to a service program that is defined by a client side for a combination of functions whose uses are authorized for said client side, among functions provided by a network platform side, and whose identification information is registered in said network platform side, comprising:
a unit that detects a specific trigger;
a unit that identifies a service program corresponding to said specific trigger;
a unit that judges whether execution of the identified service program has an influence at a predetermined level or bigger on said client terminal; and
a unit that causes the identified service program to be executed, if it is judged that said execution of the identified service program does not have said influence at said predetermined level or bigger on said client terminal.

20. An information processing apparatus, which relates to a service program that is defined by a client side for a combination of functions whose uses are authorized for said client side, among functions provided by a network platform side, and whose identification information is registered in said network platform side, comprising:
a unit that detects a trigger;
a unit that judges whether the detected trigger can be handled;
a unit that specifies a service program corresponding to the detected trigger, if the detected trigger can be handled; and
a unit that executes the specified service program.
